(19) United States
(12) Patent Application Publication
(10) Pub. No.: US 2022/0198598 A1
(43) Pub. Date: Jun. 23, 2022

(54) HIERARCHICAL ADAPTIVE CONTEXTUAL BANDITS FOR RESOURCE-CONSTRAINED RECOMMENDATION

(71) Applicant: Beijing DiDi Infinity Technology and Development Co., Ltd., Beijing (CN)

(72) Inventors: Qingyang LI, Sunnyvale, CA (US); Zhiwei QIN, San Jose, CA (US)

(21) Appl. No.: 17/124,921

(22) Filed: Dec. 17, 2020

(51) Int. Cl. G06Q 50/30; G06N 5/04; G06N 20/00; G06Q 30/02; G06Q 10/06; G01C 21/34

(52) U.S. Cl. CPC G06Q 50/30; G06N 5/04; G06N 20/00; G06Q 30/0205; G01C 21/3484; G06Q 30/0284; G06Q 30/0222; G01C 21/3438; G06Q 10/06315

(57) ABSTRACT

A computer-implemented method includes: obtaining a model comprising an environment module, a resource allocation module, and a personal recommendation module, receiving a real-time online signal of visiting the platform from a computing device of a visiting user; determining a resource allocation action by feeding user contextual data of the visiting user to the model; and based on the determined resource allocation action, transmitting a return signal to the computing device to present the resource allocation action.

### TECHNICAL FIELD

The disclosure relates generally to reinforcement learning, and in particular, to hierarchical adaptive contextual bandits for a resource-constrained recommendation.

### BACKGROUND

Contextual multi-armed bandit (MAB) achieves cutting-edge performance on a variety of problems. When it comes to real-world scenarios such as recommendation systems, however, it is important to consider the resource consumption of exploration. In practice, there is typically a non-zero cost associated with executing a recommendation (arm) in the environment, and hence, the policy should be learned with a fixed exploration cost constraint. It is challenging to learn a global optimal policy directly, since it is an NP-hard problem and significantly complicates the exploration and exploitation trade-off of bandit algorithms. Existing approaches focus on solving the problems by adopting the greedy policy which estimates the expected rewards and costs and uses a greedy selection based on each arm's expected reward/cost ratio using historical observation until the exploration resource is exhausted. However, existing methods are difficult to extend to an infinite time horizon, since the learning process will be terminated when there is no more resource. Therefore, it is desirable to improve the reinforcement learning process in the context of MAB.

Further, MAB may find its application in areas such as online ride-hailing platforms, which are rapidly becoming essential components of the modern transit infrastructure. Online ride-hailing platforms connect vehicles or vehicle drivers offering transportation services with users looking for rides. These platforms may need to allocate limited resources to their users, the effect of which may be optimized through MAB.

### SUMMARY

Various embodiments of the specification include, but are not limited to, cloud-based systems, methods, and non-transitory computer-readable media for resource-constrained recommendation through ride-hailing platform.

In some embodiments, a computer-implemented method comprises obtaining, by one or more computing devices, a model comprising an environment module, a resource allocation module, and a personal recommendation module. The environment module is configured to: cluster a plurality of users of a platform into a plurality of classes based on user contextual data of each individual user in the plurality of users, determine centric contextual information of each of the classes, output the centric contextual information of each of the classes to the resource allocation module, and output user contextual data of each individual user to the personal recommendation module. The resource allocation module comprises one or more first parameters of each of the classes and is configured to: determine probabilities of the platform making resource allocations to users in the respective classes, based on the one or more first parameters of each of the classes and the centric contextual information of each of the classes, and output the probability to the personal recommendation module. The personal recommendation module comprises one or more second parameters of each of the classes and is configured to: determine, based on user contextual data of an individual user, a corresponding class of the individual user among the classes, and the probabilities, a corresponding probability of the platform making a resource allocation to the individual user, determine, based on the one or more second parameters, different expected rewards corresponding to the platform executing different actions of making different resource allocations to the individual user in the corresponding class, and select an action from the different actions according to the different expected rewards, wherein a probability of executing the selected action is the corresponding probability. The computer-implemented method further comprises receiving, by the one or more computing devices, a real-time online signal of visiting the platform from a computing device of a visiting user; determining, by the one or more computing devices, a resource allocation action by feeding user contextual data of the visiting user to the model as the individual user and obtaining the selected action as the resource allocation action; and based on the determined resource allocation action, transmitting, by the one or more computing devices, a return signal to the computing device to present the resource allocation action.

In some embodiments, for a training of the model, the environment module is configured to receive the selected action and update the one or more first parameters and the one or more second parameters based at least on the selected action by feedbacking a reward to the resource allocation module and the personal recommendation module; and the reward is based at least on the selected action and the probability of executing the selected action.

In some embodiments, the platform is a ride-hailing platform; the real-time online signal of visiting the platform corresponds to a bubbling of a transportation order at the ride-hailing platform; the user contextual data of the visiting user comprises a plurality of bubbling features of a transportation plan of the visiting user; and the plurality of bubbling features comprise (i) a bubble signal comprising a timestamp, an origin location of the transportation plan of the visiting user, a destination location of the transportation plan, a route departing from the origin location and arriving at the destination location, a vehicle travel duration along the route, and a price quote corresponding to the transportation plan, (ii) a supply and demand signal comprising a number of passenger-seeking vehicles around the origin location, and a number of vehicle-seeking transportation orders departing from the origin location, and (iii) a transportation order history signal of the visiting user.

In some embodiments, the origin location of the transportation plan of the visiting user comprises a geographical positioning signal of the computing device of the visiting user; and the geographical positioning signal comprises a Global Positioning System (GPS) signal.

In some embodiments, the transportation order history signal of the visiting user comprises one or more of the following: a frequency of order transportation order bubbling by the visiting user; a frequency of transportation order completion by the visiting user; a history of discount offers provided to the visiting user in response to the order transportation order bubbling; and a history of responses of the visiting user to the discount offers.

In some embodiments, the determined resource allocation action corresponds to the selected action and comprises offering a price discount for the transportation plan; and the return signal comprises a display signal of the route, the price quote, and the price discount for the transportation plan.

In some embodiments, the method further comprises: receiving, by the one or more computing devices, from the computing device of the visiting user, an acceptance signal comprising an acceptance of the transportation plan of the visiting user, the price quote, and the price discount; and transmitting, by the one or more computing devices, the transportation plan to a computing device of a vehicle driver for fulfilling the transportation order.

In some embodiments, the model is based on contextual multi-armed bandits; and the resource allocation module and the personal recommendation module correspond to hierarchical adaptive contextual bandits.

In some embodiments, the action comprises making no resource distribution or making one of a plurality of different amounts of resource distribution; and each of the actions corresponds to a respective cost to the platform.

In some embodiments, the model is configured to dynamically allocate resources to individual users; and the personal recommendation module is configured to select the action from the different actions by maximizing a total reward to the platform, subject to a limit of a total cost over a time period, the total cost corresponding to a total amount of distributed resources.

In some embodiments, the method further comprises training, by the one or more computing devices, the model by feeding historical data to the model, wherein each of the different actions is subject to a total cost over a time period, wherein: the total cost corresponds to a total amount of distributed resource; and the personal recommendation module is configured to determine, based on the one or more second parameters and previous training sessions based on the historical data, the different expected rewards corresponding to the platform executing the different actions of making the different resource allocations to the individual user.

In some embodiments, the resource allocation module is configured to maximize a cumulative sum of pⱼØⱼuⱼ; pⱼ represents the probability of the platform making a resource allocation to users in a corresponding class j of the classes; Øⱼ represents a probability distribution of the corresponding class j among the classes; uⱼ represents an expected reward of the corresponding class j; and a cumulative sum of pⱼØⱼ is no larger than a ratio of a total cost budget of the platform over a time period T.

In some embodiments, the one or more first parameters comprise the pⱼ and uⱼ.

In some embodiments, the resource allocation module is configured to determine the expected reward of the corresponding class j based on centric contextual information of the corresponding class j, historical observations of the corresponding class j, and historical rewards of the corresponding class j.

In some embodiments, the model is configured to maximize a total reward to the platform over a time period T; and the model corresponds to a regret bound of O\sqrt{T}.

In some embodiments, if the corresponding class and the selected action exist in historical data used to train the model, the environment module is configured to identify a corresponding historical reward from the historical data as the reward; and if the corresponding class or the selected action does not exist in the historical data, the environment module is configured to use an approximation function to approximate the reward.

In some embodiments, the platform is an information presentation platform; the user contextual data of the visiting user comprises a plurality of visitor features of the visiting user; the plurality of visitor features comprise one or more of the following: a timestamp of the real-time online signal of visiting the platform, a geographical location of the visiting user, biographical information of the visiting user, a browsing history of the visiting user, and a history of click response to different categories of online information; the determined resource allocation action comprises one or more categories of information for display at the computing device of the visiting user; and the return signal comprises a display signal of the one or more categories of information.

In some embodiments, one or more non-transitory computer-readable storage media stores instructions executable by one or more processors, wherein execution of the instructions causes the one or more processors to perform operations comprising obtaining a model comprising an environment module, a resource allocation module, and a personal recommendation module. The environment module is configured to: cluster a plurality of users of a platform into a plurality of classes based on user contextual data of each individual user in the plurality of users, determine centric contextual information of each of the classes, output the centric contextual information of each of the classes to the resource allocation module, and output user contextual data of each individual user to the personal recommendation module. The resource allocation module comprises one or more first parameters of each of the classes and is configured to: determine probabilities of the platform making resource allocations to users in the respective classes, based on the one or more first parameters of each of the classes and the centric contextual information of each of the classes, and output the probability to the personal recommendation module. The personal recommendation module comprises one or more second parameters of each of the classes and is configured to: determine, based on user contextual data of an individual user, a corresponding class of the individual user among the classes, and the probabilities, a corresponding probability of the platform making a resource allocation to the individual user, determine, based on the one or more second parameters, different expected rewards corresponding to the platform executing different actions of making different resource allocations to the individual user in the corresponding class, and select an action from the different actions according to the different expected rewards, wherein a probability of executing the selected action is the corresponding probability. The operations further comprise receiving a real-time online signal of visiting the platform from a computing device of a visiting user; determining a resource allocation action by feeding user contextual data of the visiting user to the model as the individual user and obtaining the selected action as the resource allocation action; and based on the determined resource allocation action, transmitting a return signal to the computing device to present the resource allocation action.

In some embodiments, a system comprises one or more processors and one or more non-transitory computer-readable memories coupled to the one or more processors and configured with instructions executable by the one or more processors to cause the system to perform operations comprising: obtaining a model comprising an environment module, a resource allocation module, and a personal recommendation module. The environment module is configured to: cluster a plurality of users of a platform into a plurality of classes based on user contextual data of each individual user in the plurality of users, determine centric contextual information of each of the classes, output the centric contextual information of each of the classes to the resource allocation module, and output user contextual data of each individual user to the personal recommendation module. The resource allocation module comprises one or more first parameters of each of the classes and is configured to: determine probabilities of the platform making resource allocations to users in the respective classes, based on the one or more first parameters of each of the classes and the centric contextual information of each of the classes, and output the probability to the personal recommendation module. The personal recommendation module comprises one or more second parameters of each of the classes and is configured to: determine, based on user contextual data of an individual user, a corresponding class of the individual user among the classes, and the probabilities, a corresponding probability of the platform making a resource allocation to the individual user, determine, based on the one or more second parameters, different expected rewards corresponding to the platform executing different actions of making different resource allocations to the individual user in the corresponding class, and select an action from the different actions according to the different expected rewards, wherein a probability of executing the selected action is the corresponding probability. The operations further comprise receiving a real-time online signal of visiting the platform from a computing device of a visiting user; determining a resource allocation action by feeding user contextual data of the visiting user to the model as the individual user and obtaining the selected action as the resource allocation action; and based on the determined resource allocation action, transmitting a return signal to the computing device to present the resource allocation action.

In some embodiments, a computer system includes an obtaining module configured to obtain a model comprising an environment module, a resource allocation module, and a personal recommendation module. The environment module is configured to: cluster a plurality of users of a platform into a plurality of classes based on user contextual data of each individual user in the plurality of users, determine centric contextual information of each of the classes, output the centric contextual information of each of the classes to the resource allocation module, and output user contextual data of each individual user to the personal recommendation module. The resource allocation module comprises one or more first parameters of each of the classes and is configured to: determine probabilities of the platform making resource allocations to users in the respective classes, based on the one or more first parameters of each of the classes and the centric contextual information of each of the classes, and output the probability to the personal recommendation module. The personal recommendation module comprises one or more second parameters of each of the classes and is configured to: determine, based on user contextual data of an individual user, a corresponding class of the individual user among the classes, and the probabilities, a corresponding probability of the platform making a resource allocation to the individual user, determine, based on the one or more second parameters, different expected rewards corresponding to the platform executing different actions of making different resource allocations to the individual user in the corresponding class, and select an action from the different actions according to the different expected rewards, wherein a probability of executing the selected action is the corresponding probability. The computer system further includes a receiving module configured to receive a real-time online signal of visiting the platform from a computing device of a visiting user; a determining module configured to determine a resource allocation action by feeding user contextual data of the visiting user to the model as the individual user and obtaining the selected action as the resource allocation action; and a transmitting module configured to, based on the determined resource allocation action, transmit a return signal to the computing device to present the resource allocation action.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the specification. It is to be understood that the foregoing general description and the following detailed description are exemplary and explanatory only, and are not restrictive of the specification, as claimed.

### BRIEF DESCRIPTION OF THE DRAWINGS

Non-limiting embodiments of the specification may be more readily understood by referring to the accompanying drawings in which:

FIG. 1A illustrates an exemplary system for resource-constrained recommendation, in accordance with various embodiments of the disclosure.

FIG. 1B illustrates an exemplary system for resource-constrained recommendation, in accordance with various embodiments of the disclosure.

FIG. 2A illustrates an exemplary model for resource-constrained recommendation, in accordance with various embodiments of the disclosure.

FIG. 2B illustrates exemplary operations for resource-constrained recommendation, in accordance with various embodiments.

FIG. 2C illustrates exemplary operations for resource-constrained recommendation, in accordance with various embodiments.

FIG. 2D illustrates exemplary operations for resource-constrained recommendation, in accordance with various embodiments.

FIGS. 3A, 3B, and 3C respectively illustrate exemplary regrets of HATCH and three other algorithms, in accordance with various embodiments.

FIGS. 3D, 3E, 3F, and 3G illustrate exemplary performances of HATCH and two other algorithms, in accordance with various embodiments.

FIGS. 3H, 3I, 3J, and 3K illustrate exemplary results of executing HATCH, in accordance with various embodiments.

FIG. 3L illustrates an exemplary user interface for a news platform, in accordance with various embodiments.

FIG. 4 illustrates an exemplary method for resource-constrained recommendation, in accordance with various embodiments.

FIG. 5 illustrates an exemplary system for resource-constrained recommendation, in accordance with various embodiments.

FIG. 6 illustrates a block diagram of an exemplary computer system in which any of the embodiments described herein may be implemented.

### DETAILED DESCRIPTION

Non-limiting embodiments of the present specification will now be described with reference to the drawings. Particular features and aspects of any embodiment disclosed herein may be used and/or combined with particular features and aspects of any other embodiment disclosed herein. Such embodiments are by way of example and are merely illustrative of a small number of embodiments within the scope of the present specification. Various changes and modifications obvious to one skilled in the art to which the present specification pertains are deemed to be within the spirit, scope, and contemplation of the present specification as further defined in the appended claims.

In some embodiments, the multi-armed bandit (MAB) may be a sequential decision problem, in which an agent receives a random reward by playing one of K arms at each round and tries to maximize its cumulative reward. Various real-world applications can be modeled as MAB problems, such as incentive distribution, news recommendation, etc. Models that make full use of the observed d dimension features associated with the bandit learning may be referred to as contextual multi-armed bandits.

In some embodiments, the MAB may be applied in user recommendations under resource constraints. For example, when recommending items-for-purchase to Internet users through user devices, MAB-based methods not only focus on improving the number of orders and clicks but also balance the exploration-exploitation trade-off within a limit of exploration resource, so that CTR (Click Through Rate, which may be click/impression) and purchase rate are sought to be improved. Since the impressions of users are almost fixed within a certain scope (e.g., budget), the application can be formulated as a model of increasing the number of clicks under a budget scope. Thus, it is necessary to conduct policy learning under constrained resources which indicates that cumulative displays of all items (arms) cannot exceed a fixed budget within a given time horizon. Each action may be treated as one recommendation, and the total number of impressions may be treated as the budget. To enhance CTR, every recommendation may be treated equally and formulated as unit-cost for each arm. Recommendations may be decided by dynamic pricing.

In some embodiments, the policy may be learned to maximize an expected reward such as CTR or benefit to the platform under exploration constraints. The task may be formed as a constrained bandit problem. In such settings, a model recommends an item (arm) for an incoming context in each round, and observes a reward. Meanwhile, the execution of the action will produce the cost (e.g., a unit cost). This indicates that the exploration of policy learning takes resource consumption.

In some embodiments, a hierarchical adaptive learning structure is provided to, within a time period, dynamically allocate a limited resource among different user contexts, as well as to conduct the policy learning by making full use of the user contextual features. In one embodiment, the scale of resource allocation is considered both at the global level and for the remaining time horizon of the time period. The hierarchical learning structure may include two levels: at the higher level is a resource allocation level where the disclosed method dynamically allocates the resource according to the estimation of the user context value, and at the lower level is a personalized recommendation level where the disclosed method makes full use of contextual information to conduct the policy learning alternatively.

The technical effects of the disclosed systems and methods include at least the following. In some embodiments, adaptive resource allocation is provided to balance the efficiency of policy learning and exploration resource consumption under the remaining time horizon. Dynamic resource allocation is applied in the contextual multi-armed bandit problems. Thus, computing efficiencies of computer systems are enhanced, while conversing computing resources. In some embodiments, in order to utilize the contextual information for users, a hierarchical adaptive contextual bandits method (HATCH) is used to conduct the policy learning of contextual bandits with a budget constraint HATCH may include simulating the reward distribution of user contexts to allocate the resources dynamically and employ user contextual features for personalized recommendation. HATCH may adopt an adaptive method to allocate the exploration resource based on the remaining resource/time and the estimation of reward distribution among different user contexts. In some embodiments, various types of contextual feature information may be used to find the optimal personalized recommendation. Thus, the accuracy of the model is improved. In some embodiments, HATCH has a regret bound as low as O\sqrt{T} are provided. The regret bound represents the convergence rate of the algorithm to the optimal solution, which measures the performance of a model relative to the performance of others. The experimental results demonstrate the effectiveness and efficiency of the disclosed method on both synthetic data sets and real-world applications.

The disclosed systems and methods may be applied in resource or incentive distribution to online-platform users. In some embodiments, a user may log into a mobile phone APP or a website of an online ride-hailing platform and submit a request for transportation service—which can be referred to as bubbling. For example, a user may enter the starting and ending locations of a transportation trip and view the estimated price through bubbling. Bubbling takes place before the submission of an order of the transportation service. For example, after receiving the estimated price (with or without a discount), the user may accept the order or reject the order. If the order is accepted, the online ride-hailing platform may match a vehicle with the submitted order. Further, the disclosed systems and methods may be applied to other platforms such as news platforms, e-commerce platforms, etc.

Before the user gets to accept or reject the order, the computing system of the online ride-hailing platform may offer incentives such as discounts to encourage acceptance. For example, the computing system of the online ride-hailing platform may return a quoted price and a discount offer to display at the user's device for the user to accept the order. With a limited amount of resources such as the incentives, it is desirable for the platform to strategize the distribution of the incentive to maximize the return to the platform. This improves computer functionality. For example, the computing efficiency of the platform computing system is improved because HATCH simulation estimates the overall long-term return to the platform based on individual user resource allocation decisions, such that the platform may simply call a trained model in real-time to generate resource allocation decisions. Further, the effectiveness and accuracy of the resource allocation decisions are improved.

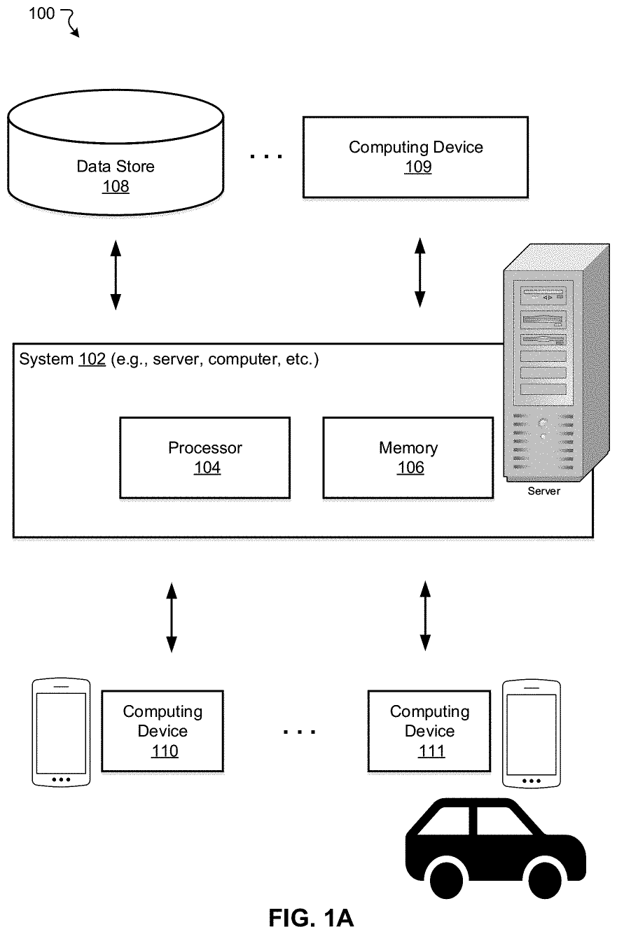

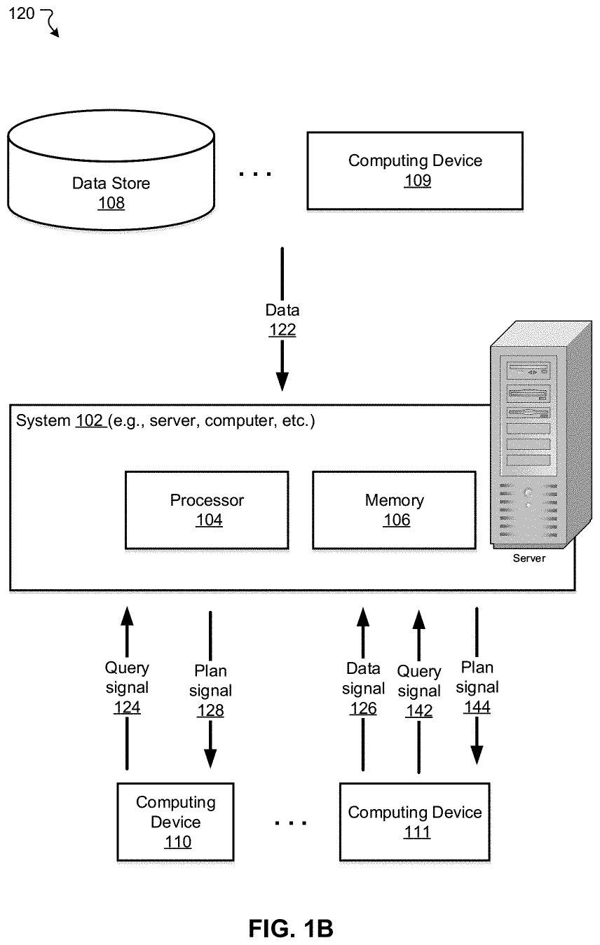

FIG. 1A illustrates an exemplary system 100 for resource-constrained recommendation, in accordance with various embodiments. The operations shown in FIG. 1A and presented below are intended to be illustrative. As shown in FIG. 1A, the exemplary system 100 may comprise at least one system 102 (e.g., a computing system) that includes one or more processors 104 and one or more memories 106. The memory 106 may be non-transitory and computer-readable. The memory 106 may store instructions that, when executed by the one or more processors 104, cause the one or more processors 104 to perform various operations described herein. The system 102 may be implemented on or as various devices such as mobile phones, tablets, servers, computers, wearable devices (smartwatches), etc. The system 102 above may be installed with appropriate software (e.g., platform program, etc.) and/or hardware (e.g., wires, wireless connections, etc.) to access other devices of the system 100.

The system 100 may include one or more data stores (e.g., a data store 108) and one or more computing devices (e.g., a computing device 109) that are accessible to the system 102. In some embodiments, the system 102 may be configured to obtain data (e.g., historical ride-hailing data such as location, time, and fees for multiple historical vehicle transportation trips) from the data store 108 (e.g., a database or dataset of historical transportation trips) and/or the computing device 109 (e.g., a computer, a server, or a mobile phone used by a driver or passenger that captures transportation trip information such as time, location, and fees). The system 102 may use the obtained data to train a model for resource-constrained recommendation. The location may be transmitted in the form of GPS (Global Positioning System) coordinates or other types of positioning signals. For example, a computing device with GPS capability and installed on or otherwise disposed in a vehicle may transmit such location signal to another computing device (e.g., a computing device of the system 102).

The system 100 may further include one or more computing devices (e.g., computing devices 110 and 111) coupled to the system 102. The computing devices 110 and 111 may include devices such as cellphones, tablets, in-vehicle computers, wearable devices (smartwatches), etc. The computing devices 110 and 111 may transmit or receive signals (e.g., data signals) to or from the system 102.

In some embodiments, the system 102 may implement an online information or service platform. The service may be associated with vehicles (e.g., cars, bikes, boats, airplanes, etc.), and the platform may be referred to as a vehicle platform (alternatively as service hailing, ride-hailing, or ride order dispatching platform). The platform may accept requests for transportation service, identify vehicles to fulfill the requests, arrange for passenger pick-ups, and process transactions. For example, a user may use the computing device 110 (e.g., a mobile phone installed with a software application associated with the platform) to request a transportation trip arranged by the platform. The system 102 may receive the request and relay it to one or more computing device 111 (e.g., by posting the request to a software application installed on mobile phones carried by vehicle drivers or installed on in-vehicle computers). Each vehicle driver may use the computing device 111 to accept the posted transportation request and obtain pick-up location information. Fees (e.g., transportation fees) may be transacted among the system 102 and the computing devices 110 and 111 to collect trip payment and disburse driver income. Some platform data may be stored in the memory 106 or retrievable from the data store 108 and/or the computing devices 109, 110, and 111. For example, for each trip, the location of the origin and destination (e.g., transmitted by the computing device 110), the fee, and the time may be collected by the system 102.

In some embodiments, the system 102 and the one or more of the computing devices (e.g., the computing device 109) may be integrated in a single device or system. Alternatively, the system 102 and the one or more computing devices may operate as separate devices. The data store(s) may be anywhere accessible to the system 102, for example, in the memory 106, in the computing device 109, in another device (e.g., network storage device) coupled to the system 102, or another storage location (e.g., cloud-based storage system, network file system, etc.), etc. Although the system 102 and the computing device 109 are shown as single components in this figure, it is appreciated that the system 102 and the computing device 109 can be implemented as single devices or multiple devices coupled together. The system 102 may be implemented as a single system or multiple systems coupled to each other. In general, the system 102, the computing device 109, the data store 108, and the computing device 110 and 111 may be able to communicate with one another through one or more wired or wireless networks (e.g., the Internet) through which data can be communicated.

FIG. 1B illustrates an exemplary system 120 for resource-constrained recommendation, in accordance with various embodiments. The operations shown in FIG. 1B and presented below are intended to be illustrative. In various embodiments, the system 102 may obtain data 122 (e.g., historical data) from the data store 108 and/or the computing device 109. The historical data may comprise, for example, historical vehicle trajectories and corresponding trip data such as time, origin, destination, fee, etc. Some of the historical data may be used as training data for training models. The obtained data 122 may be stored in the memory 106. The system 102 may train a model with the obtained data 122.

In some embodiments, the computing device 110 may transmit a signal (e.g., query signal 124) to the system 102. The query signal 124 may be a real-time online signal of visiting the platform from a visiting user (e.g., a passenger). The computing device 110 may be associated with a passenger seeking transportation service. The query signal 124 may correspond to a bubble signal comprising information such as a current location of the vehicle, a current time, an origin of a planned transportation, a destination of the planned transportation, etc. In the meanwhile, the system 102 may have been collecting data (e.g., data signal 126) from each of a plurality of computing devices such as the computing device 111. The computing device 111 may be associated with a driver of a vehicle described herein (e.g., taxi, a service-hailing vehicle). The data signal 126 may correspond to a supply signal of a vehicle available for providing transportation service.

In some embodiments, the system 102 may obtain a plurality of bubbling features of a transportation plan of a user. For example, bubbling features of a user bubble may include (i) a bubble signal comprising a timestamp, an origin location of the transportation plan of the user, a destination location of the transportation plan, a route departing from the origin location and arriving at the destination location, a vehicle travel duration along the route, and/or a price quote corresponding to the transportation plan, (ii) a supply and demand signal comprising a number of passenger-seeking vehicles around the origin location, and a number of vehicle-seeking transportation orders departing from the origin location, and (iii) a transportation order history signal of the user. The bubble signal may be collected from the query signal 124 and/or other sources such as the data stores 108 and the computing device 109 (e.g., the timestamp may be obtained from the computing device 109) and/or generated by itself (e.g., the route may be generated at the system 102). The supply and demand signal may be collected from the query signal of a computing device of each of multiple users and the data signal of a computing device of each of multiple vehicles. The transportation order history signal may be collected from the computing device 110 and/or the data store 108. In one embodiment, the vehicle may be an autonomous vehicle, and the data signal 126 may be collected from the computing device 111 implemented as an in-vehicle computer.

In some embodiments, when making the assignment, the system 102 may send a plan (e.g., plan signal 128) to the computing device 110 or one or more other devices. The plan signal 128 may include a price quote, a discount signal, the route departing from the origin location and arriving at the destination location, an estimated time of arrival at the destination location, etc. The plan signal 128 may be presented on the computing device 110 for the user to accept or reject.

In some embodiments, the computing device 111 may transmit a query (e.g., query signal 142) to the system 102. The query signal 142 may be a real-time online signal of visiting the platform from a visiting user (e.g., a driver). The query signal 142 may include a GPS signal of a vehicle driven by the driver, a message indicating that the driver is available for providing transportation service, a timestamp or time period corresponding to the transportation service, etc. The system 102 send a plan (e.g., plan signal 144) to the computing device 111 or one or more other devices. The plan signal 144 may include an incentive (e.g., receiving a bonus after completing 10 orders by today). The plan signal may be presented on the computing device 111 for the driver to accept or reject.

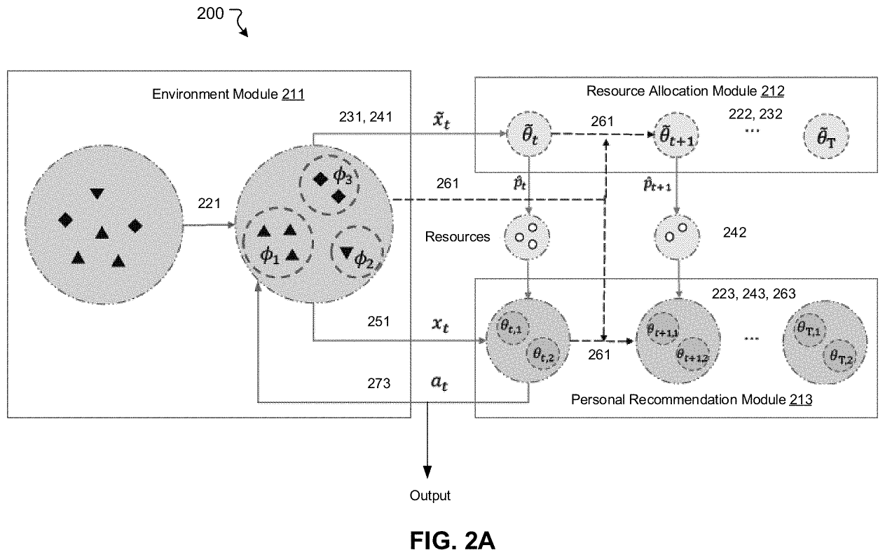

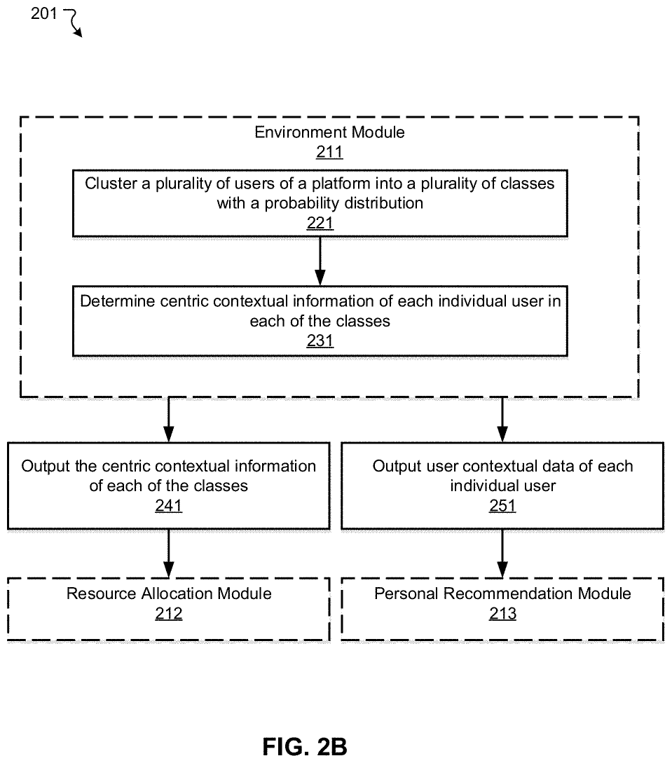

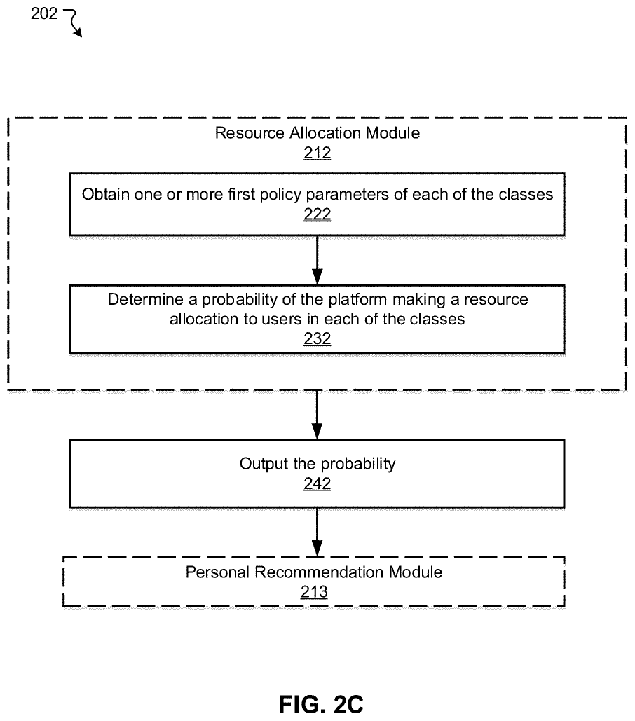

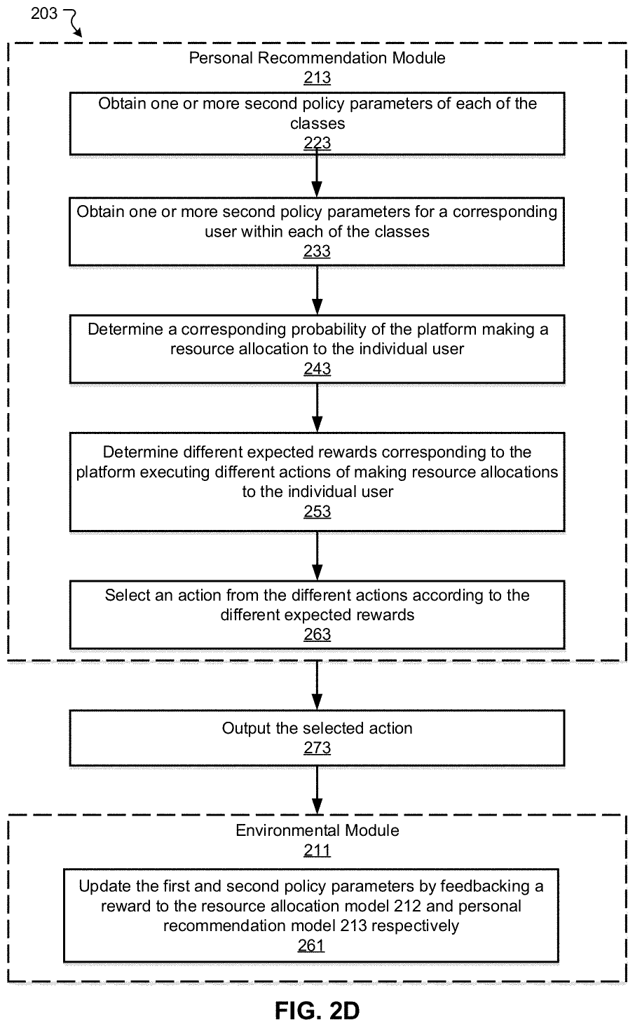

FIG. 2A illustrates an exemplary model 200 for resource-constrained recommendation, in accordance with various embodiments of the disclosure. The model may be implemented in various environments including, for example, by the system 100 of FIG. 1A and FIG. 1B. The exemplary model 200 may be implemented by one or more components of the system 102. For example, a non-transitory computer-readable storage medium (e.g., the memory 106) may store instructions that, when executed by a processor (e.g., the processor 104), cause the system 102 (e.g., the processor 104) to create and call the model 200. As shown, the model 200 may include an environment module 211, a resource allocation module 212, and a personal recommendation module 213. In some embodiments, the above-described modules may be implemented by firmware, software, hardware, or a combination of two or more thereof. For example, a module may be implemented as a software-based service that provides various interfaces (e.g., APIs) for communicating with another module and/or a user. The operations presented below among the various modules of the model 200 are intended to be illustrative. Depending on the implementation, the operations may include additional, fewer, or alternative steps performed in various orders or in parallel.

In some embodiments, at step 221, the environment module 211 may cluster a plurality of users of a platform (e.g., a ride-hailing platform, a news platform, an e-commerce platform) into a plurality of classes j with a probability distribution Øⱼ, based on user contextual data of each individual user in the plurality of users. Further details of step 221 may be referred to FIG. 2B described below.

In some embodiments, at step 231, step 241, and step 251, the environment module 211 may determine centric contextual information, denoted as \tilde{x}ₜ, of each of the classes j, and output (i) the centric contextual information (e.g., common bubbling feature of the user class, common topics of news articles clicked by the user class) of each of the classes, denoted as \tilde{x}ₜ, to the resource allocation module 212, and (ii) user contextual data (e.g., bubbling history, historically clicked news articles) of each individual user, denoted as xₜ, to the personal recommendation module 213. Further details of step 231, step 241, and step 251 may be referred to FIG. 2B described below.

In some embodiments, at step 222 and step 232, the resource allocation module 212 may obtain one or more first policy parameters (e.g., a discount policy), denoted as \tilde{θ}ₜ, of each of the class j, and determine a probability, denoted as \tilde{p}ₜ, of the platform making a resource allocation to users in each of the classes j, based on the one or more first policy parameters \tilde{θ}ₜ of each of the classes with the probability distribution Øⱼ, and the centric contextual information of each of the classes \tilde{x}ₜ. Further details of step 222 and step 232 may be referred to FIG. 2B described below.

In some embodiments, at step 242, the resource allocation module 212 may output the probability \tilde{p}ₜ of the platform making a resource allocation to users in each of the classes to the personal recommendation module 213. Further details of step 242 may be referred to FIG. 2C described below.

In some embodiments, at step 223, the personal recommendation module 213 may obtain one or more second policy parameters (e.g., discount policy), denoted as θ_{t,i}, of each individual user within each of the classes. Further details of step 223 may be referred to FIG. 2D described below.

In some embodiments, at step 243, the personal recommendation module 213 may determine, based on the one or more second policy parameters θ_{t,i}, different expected rewards (e.g., sending a ride request, clicking on a recommended article), denoted as uⱼ, corresponding to the platform executing different actions of making different resource allocations (e.g., offering a discount, recommending a news article) to the individual user. Further details of step 243 may be referred to FIG. 2D described below.

In some embodiments, at step 263 and step 273, the personal recommendation module 213 may select an action (e.g., the action of making an offer and/or a recommendation), denoted as aₜ, from the different actions according to the different expected rewards, and output the selected action. Further details of step 263 and step 273 may be referred to FIG. 2D described below.

In some embodiments, at step 261, for a training, the environment module 211 may obtain the selected action, and update the one or more first policy parameters \tilde{θ}ₜ and the one or more second policy parameters θ_{t,i} based at least on the selected action by feedbacking a reward (e.g., profit from a ride, total clicks of a news article), denoted by rₜ, to the resource allocation module 212 and the personal recommendation module 213. Further details of step 261 may be referred to FIG. 2D described below.

FIG. 2B illustrates exemplary operations 201 between the environment module 211 and the resource allocation module 212, in accordance with various embodiments. The operations 201 may be implemented in various environments including, for example, by the system 100 of FIG. 1A and FIG. 1B. The exemplary operations 201 may be implemented by one or more components of the system 102. For example, a non-transitory computer-readable storage medium (e.g., the memory 106) may store instructions that, when executed by a processor (e.g., the processor 104), cause the system 102 (e.g., the processor 104) to perform the operations 201. The operations 201 presented below are intended to be illustrative. Depending on the implementation, the operations 201 may include additional, fewer, or alternative steps performed in various orders or in parallel.

In some embodiments, at step 221, the environment module 211 may cluster a plurality of users of a platform into a plurality of classes j with the probability distribution Øⱼ. For example, for a plurality of users of a platform, at step 221, the environment module 211 may cluster the plurality of users of the platform into three plurality of classes with the probability distribution Ø₁, Ø₂, and Ø₃.

In some embodiments, at step 231, the environment module 211 may determine centric contextual information \tilde{x}ₜ of each of the classes j. For example, for a first class (j=1), at step 231, the environment module 211 may determine its centric contextual information \tilde{x}₁, such as users within the first class sharing similar bubbling features and/or provided similar responses to certain recommendations. Similarly, at step 231, the environment module 211 may determine centric contextual information \tilde{x}₂ of a second class (j=2) and centric contextual information \tilde{x}₃ of a third class (j=3).

In some embodiments, at step 241, the environment module 211 may output the centric contextual information \tilde{x}ₜ of class j into the resource allocation module 212. For example, for the first, second, and third classes, at step 241 the environment module 211 may output contextual information \tilde{x}₁, \tilde{x}₂ and \tilde{x}₃ of each of the respective classes into the resource allocation module 212.

In some embodiments, at step 251, the environment module 211 may output user contextual data xₜ (e.g., personal bubbling feature, preferred topics on news article) of each individual user. For example, for the plurality of users, at step 251, the environment module 211 may output user contextual data x₁ of a first user to the personal recommendation module 213. The user contextual data xₜ may include information related to a user's interaction with the platform. For example, the user contextual data xₜ may include a plurality of bubbling features of a user.

FIG. 2C illustrates exemplary operations 202 between the resource allocation module 212 and the personal recommendation module 213, in accordance with various embodiments. The operations 202 may be implemented in various environments including, for example, by the system 100 of FIG. 1A and FIG. 1B. The exemplary operations 202 may be implemented by one or more components of the system 102. For example, a non-transitory computer-readable storage medium (e.g., the memory 106) may store instructions that, when executed by a processor (e.g., the processor 104), cause the system 102 (e.g., the processor 104) to perform the operations 202. The operations 202 presented below are intended to be illustrative. Depending on the implementation, the operations 202 may include additional, fewer, or alternative steps performed in various orders or in parallel.

In some embodiments, at step 222, the resource allocation module 212 may obtain one or more first policy parameters \tilde{θ}ₜ (e.g., discount policy) of each of the classes (e.g., user classes determined by the environment module 211) with the probability distribution Øⱼ. The one or more first policy parameters \tilde{θ}ₜ may be trained through the disclosed algorithm until the objective function is maximized. For instance, for the first class with the probability distribution Ø₁, the resource allocation module 212 may obtain a first learning set of one or more first policy parameters \tilde{θ}₁ at step 222.

In some embodiments, at step 232, the resource allocation module 212 may determine a probability \tilde{p}ₜ of the platform making a resources allocation (e.g., offering a discount, recommending a news article) to users in each of the classes. For instance, for users in the first class, at step 232, the resource allocation module 212 may determine a probability \tilde{p}₁ that the platform will recommend resources to users in class 1 based on the first set of one or more first policy parameters \tilde{θ}₁. The resource may include, for example, discount, news, and the like that the platform seeks to recommend to the respective plurality of classes j. The probability \tilde{p}ₜ may be any number between 0% and 100% and be determined by the resource allocation module 212.

In some embodiments, at step 242, the resource allocation module 212 may output the probability \tilde{p}ₜ determined in step 232 into the personal recommendation module 213.

FIG. 2D illustrates exemplary operations 203 between the personal recommendation module 213 and the environment module 211, in accordance with various embodiments. The operations 203 may be implemented in various environments including, for example, by the system 100 of FIG. 1A and FIG. 1B. The exemplary operations 203 may be implemented by one or more components of the system 102. For example, a non-transitory computer-readable storage medium (e.g., the memory 106) may store instructions that, when executed by a processor (e.g., the processor 104), cause the system 102 (e.g., the processor 104) to perform the operations 203. The operations 203 presented below are intended to be illustrative. Depending on the implementation, the operations 203 may include additional, fewer, or alternative steps performed in various orders or in parallel.

In some embodiments, at step 223, the personal recommendation module 213 may obtain one or more second policy parameters (e.g., discount policies) θ_{t,i} of each of the classes (t stands for the t-th round of training iteration, and i stands for the i-th user). For instance, for the first round, at step 223, the personal recommendation module 213 may obtain a first learning set of one or more second policy parameters θ_{1,i}.

In some embodiments, at step 233, the personal recommendation module 213 may determine one or more second policy parameters θ_{t,i} for a corresponding user within each of the classes. For instance, for a first corresponding user within the first class with the probability distribution Ø₁, at step 233, the personal recommendation module 213 may obtain a first learning set of one or more second policy parameters Ø_{1,1}. Similarly, for a second corresponding user within the first class with the probability distribution Ø₁, at step 233, the personal recommendation module 233 may obtain a first learning set of one or more second policy parameters θ_{1,2}. The one or more second policy parameters θ_{t,i} may be trained through the disclosed algorithm until the objective function is maximized.

In some embodiments, at step 243, the personal recommendation module 213 may determine a corresponding probability of the platform making a resource allocation (e.g., offering discounts, recommending news articles) to the individual user.

In some embodiments, at step 253, the personal recommendation module 213 may determine different expected rewards uⱼ corresponding to the platform executing different actions (e.g., the action of making an offer/recommendation) of making resource allocations to the individual user. Each expected reward reflects the total reward (e.g., profit from ordered rides, a number of clicks of news articles) that the platform may obtain from the plurality class of users based on different actions that the platform may take. The expected rewards may each depend on whether the user accepts recommendation of the ride-hailing platform to complete a bubbled order, whether the user clicks on a new article recommended by the new platform, etc.

In some embodiments, at step 263, the personal recommendation module 213 may select an action aₜ (e.g., the action of offering/recommending) from the different actions according to the different expected rewards uⱼ (e.g., clicking a recommended news hyperlink, and bubbling activities on a ride-hailing platform). For example, for users in the first class, at step 263, the personal recommendation module 213 may select an action a₁ that maximizes the expected reward. The action may include: recommending information (e.g., discount policy, news article), and proposing a discount to a user of the platform.

In some embodiments, at step 273, the personal recommendation module 213 may output the selected action aₜ (e.g., actually offer the discount/recommend the news article). For example, during training, the selected action may be outputted to the environmental module 211. For another example, in a real application, the platform may execute the action to make a resource distribution decision.

In some embodiments, at step 261, for each training cycle, the environment module 211 may update the one or more first and second policy parameters by feedbacking a total reward rₜ (e.g., total clicks on a recommended news hyperlink, and gross bubbling activities on a ride-hailing platform) to the resource allocation module 212 and personal recommendation module 213 respectively. For example, for the first class with the probability distribution Ø₁, after the first training cycle, at step 261, the environment module 211 may update the first one or more first policy parameters \tilde{θ}₁ to a second one or more first policy parameters \tilde{θ}₂ in the resource allocation module 212, and update the first one or more second parameters θ_{1,i} to a second one or more second parameters θ_{2,i} in the personal recommendation module 213 by feedbacking a total reward r₁ to the resource allocation module 212 and personal recommendation module 213 respectively

The model 200 may be used in various applications. In some embodiments, the MAB may be applied in a sequential decision problem and/or an online decision making problem. In some embodiments, the bandit algorithm updates the parameters based on feedback from the environment, and a cumulative regret measures the effect of policy learning. The model may be applied in various real-world scenarios, such as online recommendation system (e.g., news recommendation), incentive distribution (e.g., online advertising, discount allocation on a ride-hailing platform), etc.

In some embodiments, the MAB may be applied in recommending resources to users under contextual constraints, and contextual feature information may be utilized to make the choice of the optimal arm (e.g., a recommended action) to play in the current round. For example, when recommending news to users to Internet users through news websites, MAB-based methods may enhance its performance by making recommendations based on relevant contextual information (e.g., user's news reviewing history, topic preferences).

In some embodiments, the MAB may observe a d-dimensional feature vector, which includes contextual information, before making a recommendation in round t to maximize the total reward of the recommendation. Thus, in some embodiments, the MAB agent may learn the relationship between the contexts and the cumulative rewards. In some embodiments, the HATCH method is based on the assumption of a linear payoff function between the contexts and the cumulative rewards. In some embodiments, for a K armed stochastic bandit system, in each round t, the MAB agent may observe an action set [symbol] ₜ independent of the user feature context xₜ. In some embodiments, based on observed payoffs in previous trials, the MAB agent may determine the expectation of the total reward, denoted as r_{t, a}_{ₜ}, which may be modeled as a linear function [symbol] [rₜ|x_{t, a}_{ₜ}]=x_{t, a}_{ₜ}^{T}θ*ₐ. In some embodiment, after choosing an action aₜ, the MAB agent may receive a payoff cost costₓ_{ₜ}_{, a}_{ₜ}. In some embodiments, the MAB agent may choose an action aₜ∈ [symbol] ₜ with the maximum expectation of the total reward r_{t, a}_{ₜ} at a trial t.

In some embodiments, the MAB may be applied in user recommendation under resource constraints (e.g., the resource is limited), which indicates that cumulative displays of all resources cannot exceed a fixed budget within a given time horizon T. In some embodiments, the resource constraints may relate to real-world scenarios, in which the budget is limited and a cost may be incurred with each chosen action aₜ. For example, on a news platform, a cost may incur after a news article is recommended at a display location, because the platform may bear a cost to bring Internet user traffic to the display location, and the recommendation of a news article deprives recommendations of other new articles at the display location. Thus, a non-optimal action (arm) may dramatically reduce the total rewards of the MAB. Thus, to maximize rewards under a budgeted MAB, it may be necessary to conduct policy learning under constrained resources. In some embodiments, the MAB may be required to consider an infinite amount of user contextual data (e.g., a user's historical interactions with the platform, personal preference, etc.) in a limited feature space.

In some embodiments, a hierarchical adaptive framework may balance the efficiency between policy learning and exploration of resources. In some embodiments, the budget constraint may be set in the following manner in the contextual bandits problem: given a total amount of resource B and a total time-horizon T, the total t-trail payoff may be defined as Σₜ₌₁^{T}r_{t, a}_{ₜ} in the learning process. In some embodiments, the total optimal rewards may be denoted as U*(T, B)= [symbol] [Σₜ₌₁^{T}r_{t, a*}_{ₜ}], and the objective for the MAB is to maximize the total rewards during T rounds under the constraints of exploration resource and time-horizon. Thus, the objective function may be formulating the objection function as:

$$Maximize {U}^{*} ( T , B ) = 𝔼 [ {\sum }_{t = 1}^{T} {r}_{t , {a}_{t}^{*}} ]$$

$$s . t . {\sum }_{t = 1}^{T} {c}_{{x}_{t} , {a}_{t}} \leq B$$

In some embodiments, an associated cost, denoted as cₓ_{ₜ}_{, a}_{ₜ}, may incur when recommending an action aₜ to a user with user contextual data xₜ at a round t. Thus, in some embodiments, the regret (e.g., the difference between the reward of a possible action and the reward of an actual action) may be determined as R(T, B)=U*(T, B)−U(T, B), where U*(T, B) may be the total optimal rewards (e.g., the rewards for which each recommended action would have led to the most rewards for the round), and U(T, B) may be the total rewards based on recommended actions by HATCH. In some embodiments, the objective of the MAB is to minimize the regret function R(T, B).

In some embodiments, as shown above, a hierarchical structure may be constructed to reasonably allocate the limited resources, and to efficiently optimize policy learning. In some embodiments, the HATCH may include an upper level (e.g., the resource allocation module 212) in which the HATCH may allocate resources by considering users' centric contextual information, remaining resources (e.g., time, budget), and the total reward. In some embodiments, the HATCH may include a lower level (e.g., the personal recommendation module 213) in which the HATCH may utilize the user contextual data of each individual user to determine an expected reward and to recommend an action to maximize the expected reward with the constraint of allocated exploration resource.

In some embodiments, the resource allocation process may be divided into two steps to simplify the problems of direct resource allocation and conduction policy learning. First, in some embodiments, the resource is dynamically allocated by the centric contextual information of each user class. Second, in some embodiments, a historical logging dataset may be employed to evaluate the user contextual data. In some embodiments, an adaptive linear programming is adopted to solve the resource allocation problem, and to estimate the expectation of the reward.

In some embodiments, Linear Programming (LP) may be applied to solve the problem that the exploration resource and time horizon might grow infinitely with the proportion of ρ=B/T. In some embodiments, when the average resource constraints are fixed as ρ=B/T, the LP function may provide a policy on whether to choose or skip actions recommended by MAB.

In some embodiments, the remaining resource bₜ may be constantly changing during the remaining time τ. Thus, the averaged resource constraint may be replaced as ρ=bₜ/τ, and a Dynamic resource Allocation method (DRA) may be applied to address the dynamic average resource constraint. In some embodiments, the centric contextual information and the user contextual data may be indefinite and may not be represented numerically.

In some embodiments, a finite plurality of users [symbol] may be clustered into a plurality of classes based on user contextual data of each individual user in the plurality of users. In some embodiments, in round t, when the environmental module 211 executes the selected action aₜ, a cost may occur in the environmental module 211. For example, in some embodiments, when a selected action aₜ is recommended, the recommendation may consume resources. Thus, in some embodiments, if the selected action is not a dummy (e.g., aₜ=0), the cost in the environmental module 211 may be assigned as 1.

In some embodiments, a class, denoted as j, which includes users with similar user contextual data, may expect a reward, denoted as uⱼ for each recommended action. In some embodiments, the expected rewards of a class may be constants, and may be ranked in descending order (e.g., u₁>u₂> . . . >u_{J}). In some embodiments, the expected reward for the class j, denoted as ûⱼ, may be estimated by a linear function.

In some embodiments, a MAB agent may find a user class corresponding to some user contextual data. In some embodiments, a historical user dataset may be mapped to finite classes j with the probability distribution Øⱼ(x), which reflects a probability that a user class can be found corresponding to the user contextual data.

In some embodiments, since the user context data of each user is influenced only by user preference rather than a policy parameter, it may be assumed that in rounds t in a total time-horizon T (for t∈T), the probability distribution Øⱼ(x) of a class may not drift from the round t to the round t+1 (e.g., Ø_{j,t}(x)˜Ø_{j,t+1}(x)). Thus, in some embodiments, in order to maximize the expected reward, the DRA may decide whether the algorithm should recommend the selected action (arm) in the round t by determining a probability pⱼ of the platform making a resource allocation to users in the user class j. In some embodiments, the probability pⱼ may be any number between 0-1 (e.g., pⱼ∈[0,1]). Thus, in some embodiments, the probability vectors for the user classes can be collectively denoted as [symbol] =(p₁, p₂ . . . , p_{J}). In some embodiments, for the total amount of resource B and time-horizon T, the DRA may be formulated as:

$$( D R {A}_{τ , b} ) maximize {\sum }_{j = 0}^{J} {p}_{j} {∅}_{j} {u}_{j} \\ s . t . {\sum }_{j = 1}^{J} {p}_{j} {∅}_{j} \leq \frac{B}{T} \qquad ( 1 )$$

In some embodiments, the solution of equation (1) may be denoted as pⱼ(ρ), and the maximum expected reward in a single round within averaged resource may be denoted as ν(ρ).

In some embodiments, the probability may be set as

$$p = \frac{B}{T} ,$$

where B may represent a total amount of resource and T may represent a total time horizon. Thus, a threshold of an averaged budget, denoted as \tilde{J}(p), may be determined as

$$\tilde{J} ( p ) = max \{ j : {\sum }_{j = 1}^{j} {∅}_{{j}^{′}} \leq p \} .$$

Thus, in some embodiments, the optimal solution of DRA may be summarized as:

$${p}_{j} ( ρ ) = \{ \begin{matrix}1 , & if 1 \leq j \leq \tilde{J} ( ρ ) \\ \frac{ρ - {\sum }_{{j}^{′} = 1}^{\tilde{J} ( ρ )} {∅}_{{j}^{′}}}{{∅}_{\tilde{J} ( ρ ) + 1}} & if j = \tilde{J} ( ρ ) + 1 \\ 0 , & if j > \tilde{J} ( ρ ) + 1\end{matrix}$$

In some embodiments, the static ratio of a total amount of resource B and a total time-horizon T may not be guaranteed. Thus, in some embodiments, the static ratio ρ may be replaced as b_{τ}/τ, where b_{τ} may represent the remaining resources, and τ may represent a time in round t.

In some embodiments, the expected reward uⱼ may be hard to obtain in real-world scenarios, it may be simulated. In some embodiments, the plurality of users of a platform may be clustered into a plurality of classes based on user contextual data of each individual user in the plurality of users. In some embodiments, each clustered class may include centric contextual information, which is represented by a representation center point, denoted as \tilde{x}. In some embodiments, for the j-th cluster, centric contextual information \tilde{x}ₜ may be observed in round t, and automatically mapped. In some embodiments, the expected reward between the centric contextual information \tilde{x} and the total reward r may be evaluated using a linear function [symbol] [r|\tilde{x}]=\tilde{x}^{T}\tilde{θ}ⱼ, wherein \tilde{θ}ⱼ is the one or more first policy parameter. In some embodiments, the parameters may be normalized as ∥x∥≤1 and ∥\tilde{θ}∥≤1.

In some embodiments, all historical centric contextual information of the user class j may be set collectively in a matrix \tilde{X}ⱼ=[\tilde{x}₁, \tilde{x}₁ . . . \tilde{x}ₜ], where ∥\tilde{x}∥≤1, and every vector in \tilde{X}ⱼ may be equal to \tilde{x}ⱼ. In some embodiments, the reward of each user class may be evaluated as a ridge regression, and the one or more first policy parameters of the class j may be formulated as:

\tilde{θ}_{t,j}=A_{t,j}⁻¹\tilde{X}_{t,j}Y_{t,j}^{T} (2)

where \tilde{θ}_{t,j} may be the one of more first policy parameter of the class j, Y_{t,j} may be the historical rewards of the class j (e.g., Y_{t,j}=[r₁, r₂ . . . rₜ]), and Ã_{t,j} may be a first transformation matrix determined as Ã_{t,j}=(I+\tilde{X}_{t,j}^{T}\tilde{X}_{t,j}).

In some embodiments, the estimated expected reward for the user class j at round t may be û_{t,j}=\tilde{x}ⱼ^{T}\tilde{θ}_{t,j}, where \tilde{θ}_{t,j} is the one or more first policy parameters for the user class j at round t. In some embodiments, the estimated expected reward û_{t,j} may be used to solve DRA and to determine the probability \hat{p}ₓ that the platform makes a resource allocation to users in each of the classes.

In some embodiments, the user contextual data xₜ of each individual user may be utilized to conduct the policy learning and to determine the optimal action. In some embodiments, a linear function may be established to fit the reward r and the user contextual data xₜ: [symbol] [r|xₜ]=xₜ^{T}θ_{t,j,a}, where θ_{t,j,a} is one or more second policy parameters for a user in the user class j at round t with the action a.

In some embodiments, the user contextual data matrix for an individual user in the class j after an action a may be set as: X_{t,j,a}=[x₁, x₂ . . . xₜ], where x₁, x₂ . . . xₜ are the user contextual data for the user from the first round to the t-th round.

In some embodiments, the one or more second policy parameters for a user in the user class j at round t with the action a may be determined as θ_{t,j,a}=A_{t,j,a}⁻¹X_{t,j,a}Y_{t,j,a}, where Y_{t,j,a} may be the historical rewards of a user in the class j with the action a, and A_{t,j,a} may be a transformation matrix determined as A_{t,j,a}=(λI+X_{t,j,a}^{T}X_{t,j,a}).

In some embodiments, the total reward r may be set as r=Xₜ^{T}θ*_{j,a}+ϵ, where θ*_{j,a} may be the expected value of the one or more second policy parameter θ, and ϵ may be a 1-sub-gaussian independent zero-mean random variable, where [symbol] [ϵ]=0.

In some embodiments, an action (arm) which maximize the expected reward uⱼ may be chosen from the set of recommended actions [symbol] through the following formula:

$${a}_{t}^{*} = {argmax}_{a ∈ 𝒜} {x}_{t}^{T} {θ}_{t , j , a} + ( \sqrt{λ} + α ) {‖ {x}_{t} ‖}_{{A}^{- 1}} \\ α = \sqrt{2 log ( \frac{{det ( {A}_{tj , a} )}^{\frac{1}{2}} , {det ( λ I )}^{\frac{1}{2}}}{δ} )} \qquad ( 4 )$$

where δ may be a hyperparameter, and λ>0 may be a regularized parameter, α is a constant parameter relevant to A.

In some embodiments, whether to output the selected action a*ₜ to the environmental module may be determined by a probability pⱼ of the platform making a resource allocation to users in the user class j.

In some embodiments, the regret bound of HATCH may be guaranteed by the following algorithm:

Algorithm 1 Hierarchical AdapTive Contextual bandit
metHod (HATCH)

Require: a regularized parameter λ, a total amount of resource B, a
set of recommended actions [symbol] , both of \tilde{α} and a are constant
parameters, { } refers to empty set.

| | |
|---|---|
| 1: | Init τ = T, b = B, û_{0,j} = 1 |
| 2: | Map the historical context into a finite user class set [symbol] , obtain |
| | a class ϕ for each user class distribution. |
| 3: | Init Ã_{0,j} = I, \tilde{θ}_{0,j} =0, \tilde{X}_{0,j} = { }, Y_{0,j} = { }, ∀ⱼ ∈ [symbol] |
| 4: | Init A_{0,j,a} = I, θ_{0,j,a} = 0, X_{0,j,a} = { }, Y_{0,j,a} = { }, ∀ⱼ ∈ [symbol] and |
| | ∀ₐ ∈ [symbol] |
| 5: | for t = 1, 2, . . . T do |
| 6: | Observe the context information xₜ, get the context class j of xₜ, |
| | and obtain the mapped user class context \tilde{x}ₜ. |
| 7: | Get action a by calculating the eq.8 |
| 8: | if b > 0 then |
| 9: | Obtain the probabilities \tilde{p}ⱼ(b/τ) by solving DRA(τ,b) and with u |
| | replaced by û. |
| 10: | Take action a with probability \hat{p}ⱼ(b/τ) |
| 11: | end if |
| 12: | Observe a reward r_{t,a} from the environment. |
| 13: | Update a time τ in round t, the remaining resource b |
| 14: | Update the user contextual data for an individual user in the class |
| | j after an action a as X_{t,j,a} ← [X_{t-1,j,a}: xₜ] |
| 15: | Update the historical rewards of a user in the class j after action a |
| | as Y_{t,j,a} ← [Y_{t-1,j,a}: r_{t,a}] |
| 16: | Update the historical centric contextual information of the user |
| | class j as \tilde{X}_{t,j} ← [\tilde{X}_{x-1,j,}\tilde{x}ₜ] |
| 17: | Update the historical rewards of the class j as Y_{t,j} ← [Y_{t-1,j}, r_{t,a}] |
| 18: | Update a first transformation matrix as Ã_{t,j} ← I + \tilde{X}_{t,j}^{T}\tilde{X}_{t,j} |
| 19: | Update the one or more first policy parameters as at \tilde{θ}ₜ ← |
| | Ã_{t,j}⁻¹\tilde{X}_{t,j}Y_{j,t} |
| 20: | Update the expected reward for the user class j at round t as |
| | û_{t,j} ← \tilde{x}ₜ^{T}\tilde{θ}_{t,j} |
| 21: | Update a second transformation as A_{j,t,a} ← λI + X_{t,j,a}^{T}X_{t,j,a} |
| 22: | Update the one or more second policy parameters as θ_{t,j,a} ← |
| | A_{t,j,a}⁻¹X_{t,j,a}Y_{t,j,a} |
| 23: | end for |

In some embodiments, Algorithm 1 may execute the following actions: (i) line 2 may cluster a plurality of users [symbol] into a plurality of classes j with a probability distribution Øⱼ based on user contextual data of the plurality of users; (ii) line 7 may select an action a from the different actions according to the different expected rewards; (iii) line 9 may determine a probability \hat{p}ⱼ(b/τ) of the platform making a resource allocation to users in each of the classes; and (iv) line 10 may output the selected action a based on the probability \hat{p}ⱼ(b/τ). In some embodiments, lines 13-22 may update the following parameters: a time τ in round t, the remaining resource b, the user contextual data X_{t,j,a} for an individual user in the class j after an action a, the historical rewards Y_{t,j,a} of a user in the class j after action a, the historical centric contextual information \tilde{X}_{t,j} of the user class j, the historical rewards Y_{t,j} of the class j, a first transformation matrix Ã_{t,j}, the one or more first policy parameters \tilde{θ}ₜ, the expected reward û_{t,j} for the user class j at round t, a second transformation as A_{t,j,a}, and the one or more second policy parameters θ_{t,j,a}.

In some embodiments, Algorithm 1 may output a correct order of the expected reward uⱼ, when executing the algorithm for a large number of iterations until the model converged. In some embodiments, for two user classes j and j′, the j-th class may appear Nⱼ(t−1) times until round t−1. In some embodiments, the expected rewards for the user class j may be smaller than the expected rewards for the user class j′ (e.g., uⱼ<u_{j′}), at any round t≤T, the expected rewards for the user classes j and j′ and their appearance times may satisfy the following condition:

[symbol]

(û_{j,t}≥û_{j′,t}|Nⱼ(t−1)≥lⱼ)≤2t⁻¹ (3)

where [symbol] (a|b) means the probability of condition a under the condition b, and the defined parameter

$$l = \frac{2 log T}{{( {u}_{j} - {u}_{{j}^{′}} )}^{2}} .$$

In some embodiments, the proposed HATCH may be evaluated through a theoretical analysis on the regret (e.g., the value of the difference between a made decision and the optimal decision). In some embodiments, the upper bound of the regret (maximum regret), denoted as vt(ρ), may be summarized as:

$$v t ( ρ ) = {\sum }_{j = 1}^{j ( p )} {∅}_{j} {u}_{j , t}^{*} + {p}_{j ( ρ ) + 1}^{\sim} ( ρ ) {∅}_{j ( ρ ) + 1}^{\sim} {u}_{j , {t}_{j ( ρ ) + 1}^{*}}$$

where u*_{j,t} may be the optimal expected rewards for an independent user in round t, which may be determined as u*_{j,t}= [symbol] x_{t,j,a}^{T}θ*_{j,a}.

In some embodiments, the regret for HATCH, denoted as R(T, B), for the total amount of resource B and the total time-horizon T may be defined as

R(T,B)=U*(T,B)−U(T,B) (5)

where U*(T, B) may be the total optimal rewards, and U(T, B) may be the total rewards based on recommended actions by HATCH.

In some embodiments, Theorem 1 may be defined as follows: given a user class j, an expected reward uⱼ and a fixed parameter ρ∈(0, 1), let Δj=in f{|u_{j′}−uⱼ|}, where j′∈J and j′≠j. In some embodiments, let qⱼ=Σ_{j′=1}^{j}Ø_{j′}, and for any class j∈{1, 2, . . . J}, the regret of HATCH R(T, B) with a total amount of resource B and a total time-horizon T may satisfy the following relationships:

(i) in non-boundary cases, if ρ≠qⱼ for any j∈{1, 2 . . . J},

R(T,B)=O(Jβ{square root over (Φ log T log(Φ log T)+J log T))}

(ii) in non-boundary cases, if ρ=qⱼ for any j∈{1, 2 . . . J},

R(T,B)=O(\sqrt{T}+Jβ{square root over (Φ log T log(Φ log T)+J log T))}

where λ is the regularized parameter, O( ) is a function that represents the regret bound, δ is a hyperparameter, Δ is a vector,

$$Φ = \frac{1}{{Δ}^{2}} + 2 , \\ β = \sqrt{λ} + \sqrt{2 log ( 1 / δ ) + log ( 3 + \frac{log T}{{Δ}^{2}} + 2 log T )}$$

As shown, in order to utilize the contextual information for users, HATCH may be used to conduct the policy learning of contextual bandits with a budget constraint, thereby train the model 200. In various embodiments, the effectiveness of the proposed HATCH method is illustrated below with respect to: (i) a synthetic evaluation that compares the HATCH method with three other state-of-the-art algorithms, and (ii) real-world news article recommendation on a news platform.

In some embodiments, a synthetic data set may be generated to evaluate the HATCH method. In some embodiments, generated context in the synthetic data set may contain 5 dimensions (dim=5), and each dimension has a value between 0 and 1. In some embodiments, the algorithm may be evaluated based on a plurality of 10 classes (J=10) and 10 arms may be executed for each user class to generate rewards. In some embodiments, the distribution of the 10 user class may be set collectively as [0.025, 0.05, 0.075, 0.15, 0.2, 0.2, 0.15, 0.075, 0.05, 0.025], and the expected reward uⱼ may be any random number between 0 and 1. In some embodiments, each arm may generate an optimal expected reward u_{j,a}, which is the sum of the expected reward uⱼ of each user class and a variable σ_{j,a} which measures the difference between the optimal expected reward u_{j,a} and the expected reward uⱼ (e.g., u_{j,a}=uⱼ+σ_{j,a}). In some embodiments, each dimension may have a weight w_{j,a}, which may be a random number between 0 and 1, and thus ∥w_{j,a}∥≤1. In some embodiments, a plurality of 30000 users with contextual data information may be generated and clustered into the 10 classes, and the centric contextual information \tilde{x}ₜ of each class may be determined. In some embodiments, for each class with the probability distribution Øⱼ, rewards for each of the 10 arms may be generated as a normal distribution with a mean of u_{j,a}+\tilde{x}ⱼσ_{j,a} and a variance of 1. In some embodiments, the generated rewards may be normalized as 0 or 1.

In some embodiments, the disclosed algorithm is compared with three state-of-the-art algorithms: greedy-LinUCB, random-LinUCB, and cluster-UCB-ALP. Greedy-LinUCB adopts the LinUCB strategy and chooses the optimal arm in each turn when the choice is executed, consuming one unit of resource. Random-LinUCB is the LinUCB algorithm that chooses the optimal arm in each turn. Cluster-UCB-ALP proposes an adaptive dynamic linear programming method for UCB problems (e.g., it only counts the reward and the number of occurrences for each user class and will not use class features due to the UCB setting).

In some embodiments, since the regrets may not be identical for all compared algorithms, accumulate regret, defined as the optimal reward minus the reward of executed actions, of each algorithm may be instead compared. In some embodiments, four different scenarios with time and budget constraints ρ at 0.125, 0.25, 0.375, and 0.5 may be set for each algorithm, and each algorithm may be respectively executed for 10000, 20000, and 30000 rounds.

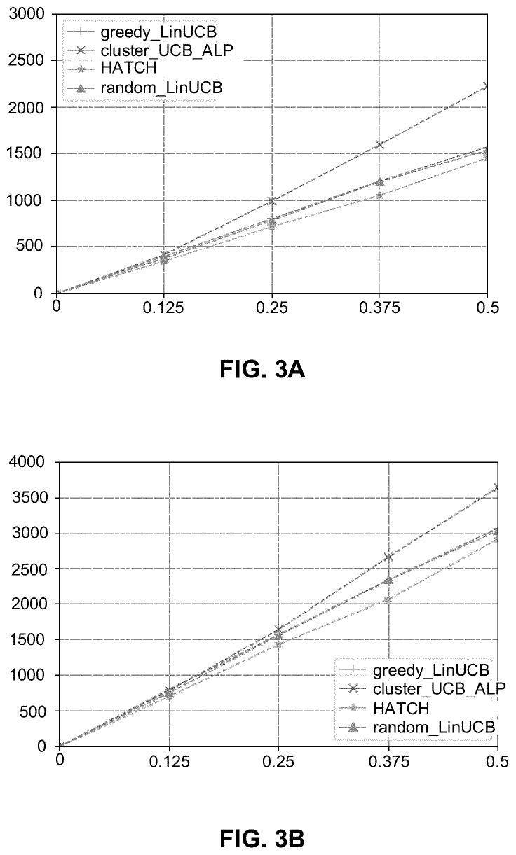

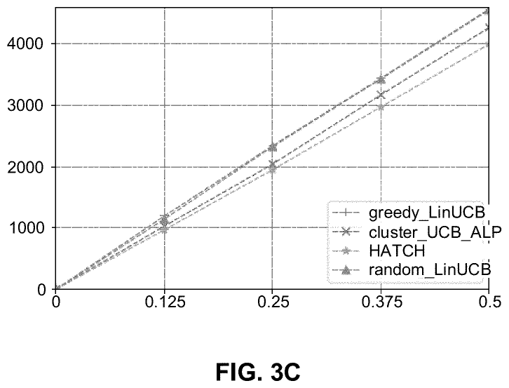

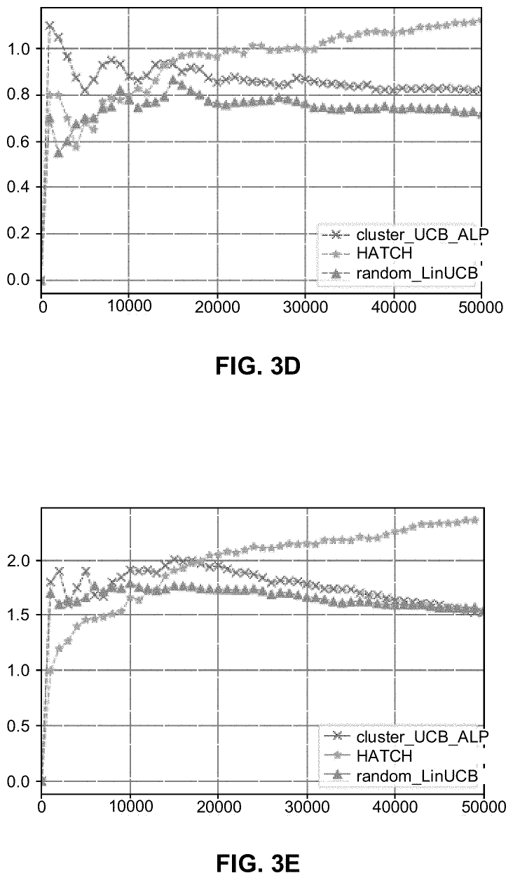

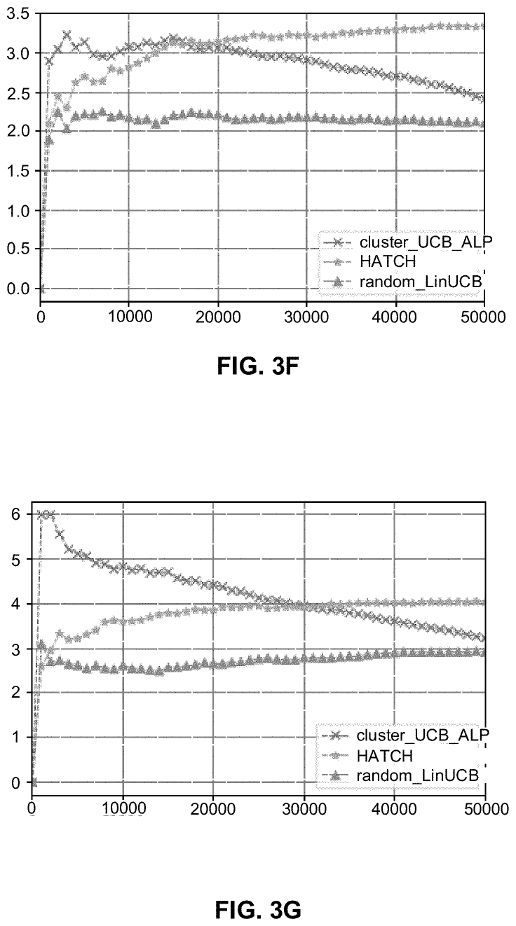

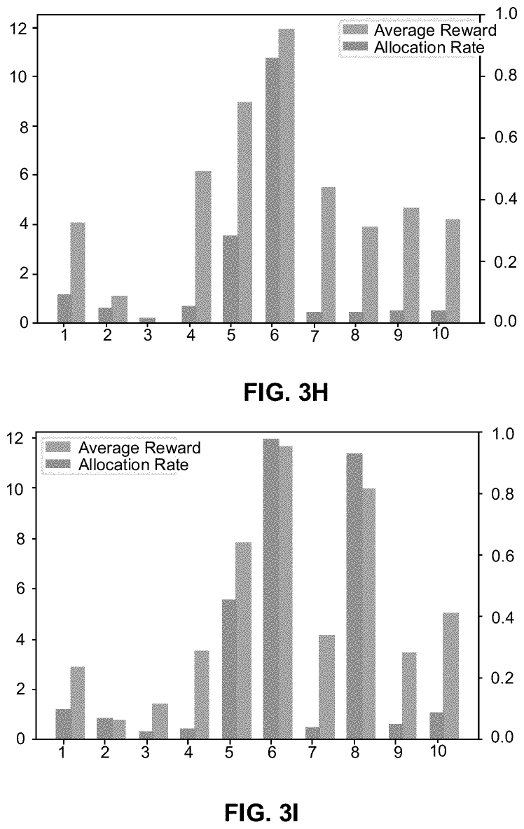

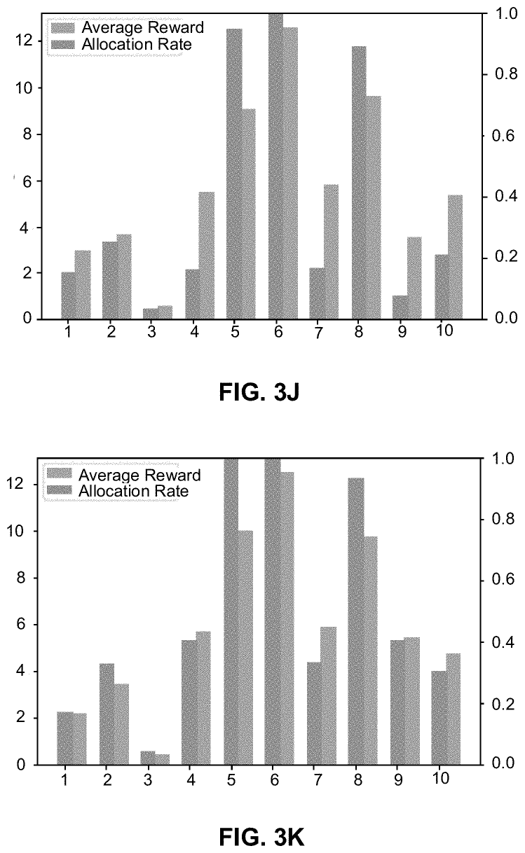

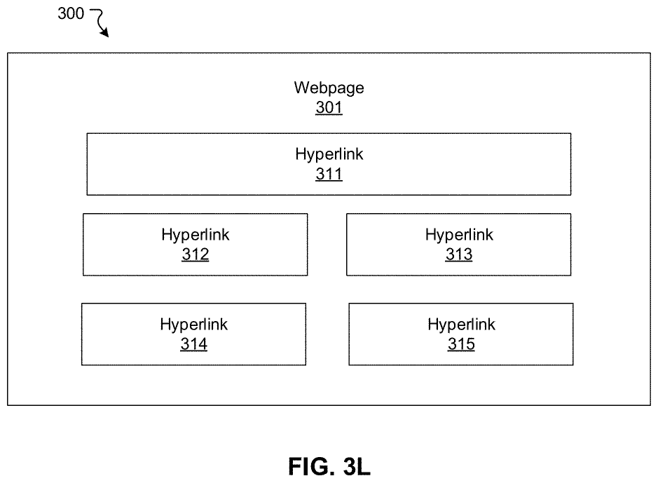

FIGS. 3A, 3B, and 3C respectively illustrate exemplary comparisons of regret between HATCH and other state-of-the-art algorithms at 10000, 20000, and 30000 execution rounds, in accordance with various embodiments. The horizontal axis reflects the different scenarios with time and budget constraints. The vertical axis reflects the accumulate regret when the choices are executed. The legend greedy_LinUCB represents experimental data for greedy_LinUCB. The legend cluster_UCB_ALP represents experimental data for cluster_UCB_ALP. The legend HATCH represents experimental data for the HATCH method. The legend random_LinUCB represents experimental data for random_LinUCB. In all three conditions, the accumulate regret of HATCH is lower than that of greedy_LinUCB, cluster_UCB_ALP, and random_LinUCB in all scenarios with different time and budget constraints. Therefore, the results show that HATCH retains the high valuable user contexts' choice, and performs better than greedy_LinUCB, cluster_UCB_ALP, and random_LinUCB.

In some embodiments, a news article recommendation in a news platform may be used to evaluate HATCH. In some embodiments, real-world data may be collected from the news platform front page for two days. In some embodiments, when users visit the news platform front page, it may recommend and display high-quality news articles from a candidate articles list. In some embodiments, 4.68 million users are observed (J=4.68M). In some embodiments, each user feature may be represented by three parameters, a user contextual data x which may include user and article selection features, a recommended action a which may include recommended candidate articles, and a reward r which may be a binary value (e.g., 0 as the user did not click the recommended candidate article, and 1 as the user clicked the recommended article). Thus, for each user, user features may be represented in the form of triples (e.g., (x, a, r)), and the user contextual dataset may collectively include user features for all users. In some embodiments, user features for 1.28 million users who were recommended the top 6 candidate articles may be randomly selected and fully shuffled to form the user contextual dataset for HATCH's learning process.

In some embodiments, half of the user contextual dataset may be applied in a predefined Gaussian Mixture Model (GMM), denoted as [symbol] (x), to obtain distributions of all clustered classes. In some embodiments, the user contextual dataset may be clustered in a plurality of 10 classes, denoted as Ø₁ to Ø₁₀, based on user contextual data of the plurality of users.

In some embodiments, an algorithm, denoted as Algorithm 2, may be used for clustering the plurality of users into the plurality of classes to avoid early drifting in class distribution (e.g., an instable class in the early stage of the clustering process may lead to an abandonment of some contextual data, and thus the choice of arms will only concentrate on several arms). In some embodiments, Algorithm 2 may include the following steps:

Algorithm 2 Evaluation from a static distribution

| Require: class distribution ∅, GMM [symbol] , | |
|---|---|
| user contextual data x, | |
| a total time horizon T > 0, policy paramters: p | |
| 1: | Set a plurality of users J = [symbol] 2 (X) |
| 2: | Set an initial historical dataset h₀ = { } {An |
| | initially empty history} |
| 3: | Set an initial total reward R₀ = 0{An initially |
| | zero total reward} |
| 4: | Set initial buckets of users Bucket = |
| | {bucket₁, bucket₂, . . . bucket_{J}} |
| 5: | for j = 1, 2, . . . J do |
| 6: | Put the x whose class is j into bucketⱼ |
| 7: | end for |
| 8: | for t = 1, 2 . . . T do |
| 9: | sample a user class j via distribution ∅ |
| 10: | repeat |
| 11: | sample event (xₜ, αₜ, rₜ) from bucketⱼ |
| 12: | until p(h_{t-1,}x) equals to aₜ |
| 13: | hₜ ← [h_{t-1,} : (xₜ, aₜ, rₜ)] |
| 14: | Rₜ ← Rₜ₋₁ + rₐ |
| 15: | delete (xₜ, αₜ, rₜ) from bucketⱼ |
| 16: | end for |
| 17: | Output: average reward = Rₜ/T |

In some embodiments, Algorithm 2 may execute the following actions: (i) line 4 may create j empty buckets; (ii) lines 5-7 may assign users with user contextual data xⱼ into the bucket bucketⱼ (e.g., users with user contextual data x₁ into bucket bucket₁; (iii) lines 8-9 may cluster a plurality of users into a plurality of classes Øⱼ; (iv) lines 10-12 may sample data randomly from the bucket bucketⱼ and select a recommended action aₜ through the current bandit algorithm; (v) line 13 may put user features of a selected user, denoted as (xₜ, aₜ, rₜ), into a historical dataset hₜ; and (vi) lines 14-15 may conduct a policy learning.

In some embodiments, Algorithm 2 may be applied to HATCH and three other baseline methods, namely random-LinUCB, greedy-LinUCB, and cluster-UCB-ALP to obtain averaged rewards (CTR) for each method and to evaluate the performance of HATCH. In some embodiments, Algorithm 2 may be run 50000 times for each method. In some embodiments, for random-LinUCB, greedy-LinUCB, and HATCH, a constant parameter α may be set as 1 (α=1). In some embodiments, the parameter α may be kept consistent for the resource allocation level and the personal recommendation level.

TABLE 1
Averaged rewards (CTR) on a news platform after
executing 50000 rounds

| | | | | |
|---|---|---|---|---|
| ρ | 0.125 | 0.25 | 0.375 | 0.5 |
| greedy-LinUCB | 0.83 | 1.69 | 2.49 | 3.29 |
| random-LinUCB | 0.72 | 1.54 | 2.11 | 2.92 |
| cluster-UCB-ALP | 0.82 | 1.52 | 2.41 | 3.23 |
| HATCH | 1.12 | 2.36 | 3.35 | 4.04 |

Table 1 illustrates exemplary average rewards (CTR) for HATCH and three other baseline methods after Algorithm 2 is executed for 50000 rounds, in accordance with various embodiments. Random-LinUCB generates the least awards for all time and budget constraints ρ, and thus has the worst performance among all evaluated methods. HATCH significantly outperforms the other methods as the expected rewards are much higher than the three baseline methods for all time and budget constraints ρ.

FIGS. 3D, 3E, 3F, and 3G illustrate exemplary comparisons for the performance of cluster_UCB_ALP, HATCH, and random_LinUCB on a news platform with time and budget constraints ρ at 0.125, 0.25, 0.375, and 0.5 respectively, in accordance with various embodiments. The horizontal axis reflects the executed rounds. The vertical axis reflects averaged rewards (CTR). The legend cluster_UCB_ALP represents experimental data for cluster_UCB_ALP. The legend HATCH represents experimental data for HATCH. The legend random_LinUCB represents experimental data for random_LinUCB. For all budget constraints, both cluster_UCB_ALP and random_LinUCB obtained the highest rewards in approximately the first 2000 rounds, and thus suggests that linear programming is reasonable for executing allocation strategies. However, the rewards obtained by both methods slowly decreases after the first 2000 rounds because as the remaining resources exhaust, the methods cannot consider the environment changes or consider user performance for personalized recommendations.

TABLE 2
Occupancy rate of user contexts among 10 classes after 50000 execution rounds

| Time and | | | | | | | | | | |
|---|---|---|---|---|---|---|---|---|---|---|
| Budget | | | | | | | | | | |
| Constraints | class1 | class2 | class3 | class4 | class5 | class6 | class7 | class8 | class9 | class10 |
| 0.125 | 0.031 | 0.014 | 0.13 | 0.063 | 0.254 | 0.483 | 0.0464 | 0.288 | 0.0346 | 0.0306 |
| 0.25 | 0.017 | 0.010 | 0.12 | 0.021 | 0.207 | 0.262 | 0.027 | 0.391 | 0.021 | 0.032 |
| 0.375 | 0.018 | 0.023 | 0.009 | 0.063 | 0.292 | 0.184 | 0.080 | 0.255 | 0.022 | 0.052 |
| 0.5 | 0.014 | 0.024 | 0.008 | 0.128 | 0.223 | 0.137 | 0.116 | 0.195 | 0.095 | 0.055 |

Table 2 illustrates exemplary normalized occupancy rates of different user classes, in accordance with various embodiments. In some embodiments, the occupancy rates may be decided by the allocation rate and the total number of users in each class. classes 5, 6, and 8 have the highest occupancy rates for all time and budget constraints ρ, whereas classes 1, 2, 9, and 10 have the lowest occupancy rates for all time and budget constraints ρ. Thus, HATCH tends to allocate more resources to classes with the higher average rewards and allocate fewer resources to classes with lower average rewards for all conditions.

FIGS. 3H, 3I, 3J, and 3K illustrate exemplary statistic results of averaged reward and resource allocation rates for 10 different classes after executing HATCH 50000 rounds on a news platform with time and budget constraints ρ at 0.125, 0.25, 0.375, and 0.5 respectively, in accordance with various embodiments. The horizontal axis reflects different classes. The left vertical axis reflects the averaged rewards (CTR). The right vertical axis reflects the resource allocation rate. The legend average reward represents the averaged rewards distribution for each class. The legend allocation rate represents the resource allocation rate distribution for each class. In some embodiments, a higher time and budget constraints ρ may represent a greater total amount of resource B (e.g., the least resource may be available to allocate for ρ=0.125, whereas the most resource may be available to allocate for ρ=0.5). When there are fewer available resources for allocation (e.g., ρ=0.125 and ρ=0.25) both the average reward and the allocation rate are predominantly distributed on a few classes (e.g., at ρ=0.125, user classes 5 and 6 have much higher distributions for both the average reward and the allocation rate than the other classes; at ρ=0.25, user classes 5, 6, and 8 have much higher distributions for both the average reward and allocation rate than the other classes). Thus, when available resources are limited, HATCH may prioritize allocating resources to classes with higher average rewards once those classes are identified. When there are greater available resources for allocation (e.g., ρ=0.375 and ρ=0.5) the resource allocation rates are higher for classes with medium averaged rewards (e.g., at ρ=0.375, some resources are allocated to classes 1, 2, 4, 7, and 10, whose averaged rewards are medium among all classes, in addition to classes 5, 6, and 8, whose averaged rewards are among all the highest; at ρ=0.5, some resources are allocated to user classes 2, 4, 7, 9 and 10, whose averaged rewards are medium among all classes, in addition to classes 5, 6, and 8, whose averaged rewards are among the highest). Thus, when available resources are adequate, HATCH may explore different resource allocation strategies before allocating most resources to classes with the highest averaged rewards.

FIG. 3L illustrates a user interface 300 for the news platform, in accordance with various embodiments. In some embodiments, a webpage 301 may be displayed in the user interface 300. The webpage 301 may include pages rendered on various hardware and software environments, such as a web browser, an APP interface on a mobile device, etc. For example, the webpage 301 may be rendered at a computing device (e.g., mobile phone) of a visiting user. In some embodiments, the webpage 301 may include a hyperlink 311 to a recommended headline, and hyperlinks 312, 313, 314, and 315 to other news articles. In some embodiments, users of the interface 300 may click on the hyperlinks 311, 312, 313, 314, and 315 to access the news. As shown, hyperlink 311 may occupy a more prominent position on the webpage 301 and thus has a higher chance of catching user attention. Thus, a recommended news article may be positioned at the hyperlink 311. Similarly, other news articles may be positioned on the webpage 301 according to corresponding resource allocation actions.

HATCH described above may be applied in news recommendations. In some embodiments, the platform is an information presentation platform. The information may include, for example, news article, e-commerce item, etc. The user contextual data of the visiting user includes a plurality of visitor features of the visiting user. The plurality of visitor features may include one or more of the following: a timestamp of the real-time online signal of visiting the platform, a geographical location of the visiting user (e.g., a GPS location of the computing device of the visiting user), biographical information of the visiting user, a browsing history of the visiting user, and a history of click response to different categories of online information (e.g., whether the user is more receptive to a certain category of information). By executing HATCH at the system 102, one or more computing devices may determine the resource allocation action, which includes one or more categories of information for display at the computing device of the visiting user. Once determined, the system 102 may transmit a return signal comprising a display signal of the one or more categories of information to the computing device of the visiting user, such that personalized information (e.g., differentially positioned news articles on the webpage 301) is displayed at the computing device.

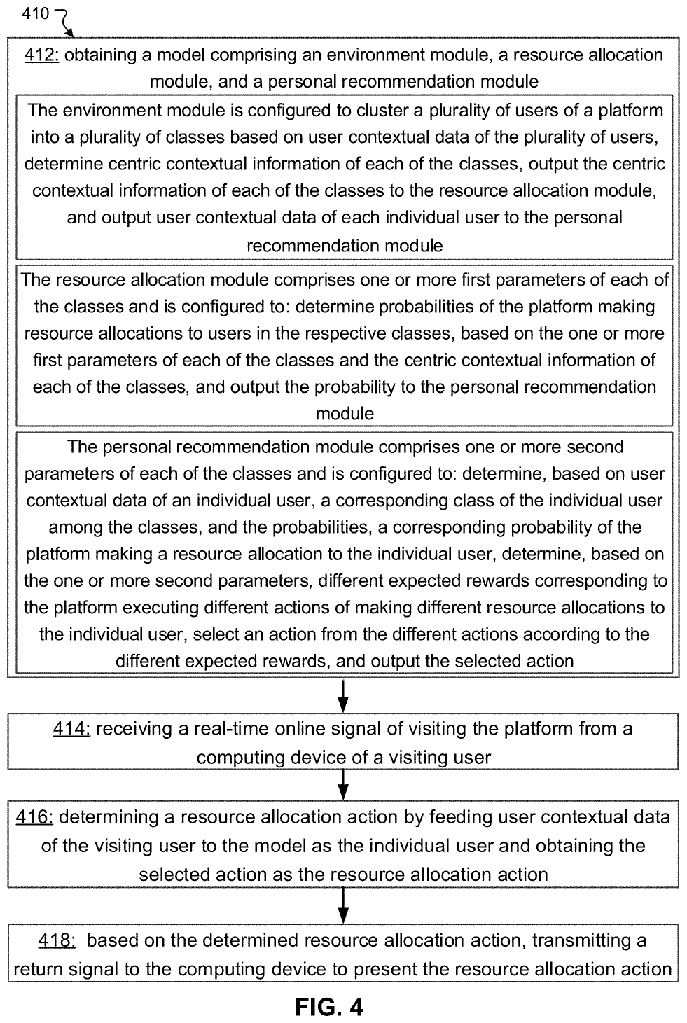

FIG. 4 illustrates a flowchart of an exemplary method 410 for resource-constrained recommendation, according to various embodiments of the present disclosure. The method 410 may be implemented in various environments including, for example, by the system 100 of FIG. 1A and FIG. 1B. The exemplary method 410 may be implemented by one or more components of the system 102. For example, a non-transitory computer-readable storage medium (e.g., the memory 106) may store instructions that, when executed by a processor (e.g., the processor 104), cause the system 102 (e.g., the processor 104) to perform the method 410. The operations of method 410 presented below are intended to be illustrative. Depending on the implementation, the exemplary method 410 may include additional, fewer, or alternative steps performed in various orders or in parallel.

Block 412 includes obtaining, by one or more computing devices, a model comprising an environment module, a resource allocation module, and a personal recommendation module. The environment module is configured to: cluster a plurality of users of a platform into a plurality of classes based on user contextual data of each individual user in the plurality of users, determine centric contextual information of each of the classes, output the centric contextual information of each of the classes to the resource allocation module, and output user contextual data of each individual user to the personal recommendation module. The resource allocation module comprises one or more first parameters of each of the classes and is configured to: determine probabilities of the platform making resource allocations to users in the respective classes, based on the one or more first parameters of each of the classes and the centric contextual information of each of the classes, and output the probability to the personal recommendation module. The personal recommendation module comprises one or more second parameters of each of the classes and is configured to: determine, based on user contextual data of an individual user, a corresponding class of the individual user among the classes, and the probabilities, a corresponding probability of the platform making a resource allocation to the individual user, determine, based on the one or more second parameters, different expected rewards corresponding to the platform executing different actions of making different resource allocations to the individual user in the corresponding class, select an action from the different actions according to the different expected rewards, wherein a probability of executing the selected action is the corresponding probability, and output the selected action. For example, if the resource allocation module determines probabilities P1 for class 1 and P2 for class 2, for an individual user (e.g., a visiting user of the platform in real-time, a virtual user used in training), the personal recommendation module may determine that the individual user falls under class 1 based on her user contextual data, and then determine the probability P1 for the individual user based on the determined class 1.

In some embodiments, for a training of the model, the environment module is configured to receive the selected action and update the one or more first parameters and the one or more second parameters based at least on the selected action by feedbacking a reward to the resource allocation module and the personal recommendation module; and the reward is based at least on the selected action and the probability of executing the selected action.

Block 414 includes receiving, by the one or more computing devices, a real-time online signal of visiting the platform from a computing device of a visiting user;

Block 416 includes determining, by the one or more computing devices, a resource allocation action by feeding user contextual data of the visiting user to the model as the individual user and obtaining the selected action as the resource allocation action. For example, the visiting user may be fed to the model as the individual user, and the model may determine her user contextual data, her corresponding class, and a recommended action for her.

Block 418 includes, based on the determined resource allocation action, transmitting, by the one or more computing devices, a return signal to the computing device to present the resource allocation action.

In some embodiments, the platform is a ride-hailing platform; the real-time online signal of visiting the platform corresponds to a bubbling of a transportation order at the ride-hailing platform; the user contextual data of the visiting user comprises a plurality of bubbling features of a transportation plan of the visiting user; and the plurality of bubbling features comprise (i) a bubble signal comprising a timestamp, an origin location of the transportation plan of the visiting user, a destination location of the transportation plan, a route departing from the origin location and arriving at the destination location, a vehicle travel duration along the route, and a price quote corresponding to the transportation plan, (ii) a supply and demand signal comprising a number of passenger-seeking vehicles around the origin location, and a number of vehicle-seeking transportation orders departing from the origin location, and (iii) a transportation order history signal of the visiting user. In various embodiments, a user of the ride-hailing platform may log into a mobile phone APP or a website of an online ride-hailing platform and submit a request for transportation service—which can be referred to as bubbling. For example, a user may enter the starting and ending locations of a transportation trip and view the estimated price through bubbling. Bubbling takes place before acceptance and submission of an order of the transportation service. For example, after receiving the estimated price (with or without a discount), the user may accept the order to submit it or reject the order. If the order is accepted, the online ride-hailing platform may match a vehicle with the submitted order.

In some embodiments, the origin location of the transportation plan of the visiting user comprises a geographical positioning signal of the computing device of the visiting user; and the geographical positioning signal comprises a Global Positioning System (GPS) signal.

In some embodiments, the transportation order history signal of the visiting user comprises one or more of the following: a frequency of order transportation order bubbling by the visiting user; a frequency of transportation order completion by the visiting user; a history of discount offers provided to the visiting user in response to the order transportation order bubbling; and a history of responses of the visiting user to the discount offers.

In some embodiments, the determined resource allocation action corresponds to the selected action and comprises offering a price discount (e.g., 10%, 20%, etc.) for the transportation plan; and the return signal comprises a display signal of the route, the price quote, and the price discount for the transportation plan. In some embodiments, the method further comprises: receiving, by the one or more computing devices, from the computing device of the visiting user, an acceptance signal comprising an acceptance of the transportation plan of the visiting user, the price quote, and the price discount; and transmitting, by the one or more computing devices, the transportation plan to a computing device of a vehicle driver for fulfilling the transportation order.

In some embodiments, the model is based on contextual multi-armed bandits; and the resource allocation module and the personal recommendation module correspond to hierarchical adaptive contextual bandits.

In some embodiments, the action comprises making no resource distribution or making one of a plurality of different amounts of resource distribution; and each of the actions corresponds to a respective cost to the platform.

In some embodiments, the model is configured to dynamically allocate resources to individual users; and the personal recommendation module is configured to select the action from the different actions by maximizing a total reward to the platform, subject to a limit of a total cost over a time period, the total cost corresponding to a total amount of distributed resources.

In some embodiments, the method further comprises training, by the one or more computing devices, the model by feeding historical data to the model, wherein each of the different actions is subject to a total cost over a time period, wherein: the total cost corresponds to a total amount of distributed resource; and the personal recommendation module is configured to determine, based on the one or more second parameters and previous training sessions based on the historical data, the different expected rewards corresponding to the platform executing the different actions of making the different resource allocations to the individual user.

In some embodiments, the resource allocation module is configured to maximize a cumulative sum of pⱼØⱼuⱼ; pⱼ represents the probability of the platform making a resource allocation to users in a corresponding class j of the classes; Øⱼ represents a probability distribution of the corresponding class j among the classes; uⱼ represents an expected reward of the corresponding class j; and a cumulative sum of pⱼØⱼ is no larger than a ratio of a total cost budget of the platform over a time period T. In some embodiments, the one or more first parameters comprise the pⱼ and uⱼ, and the one or more second parameters comprise θⱼ. In some embodiments, the resource allocation module is configured to determine the expected reward of the corresponding class j based on centric contextual information of the corresponding class j, historical observations of the corresponding class j, and historical rewards of the corresponding class j.

In some embodiments, the model is configured to maximize a total reward to the platform over a time period T; and the model corresponds to a regret bound of O\sqrt{T}.

In some embodiments, if the corresponding class and the selected action exist in historical data used to train the model, the environment module is configured to identify a corresponding historical reward from the historical data as the reward; and if the corresponding class or the selected action does not exist in the historical data, the environment module is configured to use an approximation function to approximate the reward.

In some embodiments, the platform is an information presentation platform; the user contextual data of the visiting user comprises a plurality of visitor features of the visiting user; the plurality of visitor features comprise one or more of the following: a timestamp of the real-time online signal of visiting the platform, a geographical location of the visiting user, biographical information of the visiting user, a browsing history of the visiting user, and a history of click response to different categories of online information; the determined resource allocation action comprises one or more categories of information for display at the computing device of the visiting user; and the return signal comprises a display signal of the one or more categories of information.

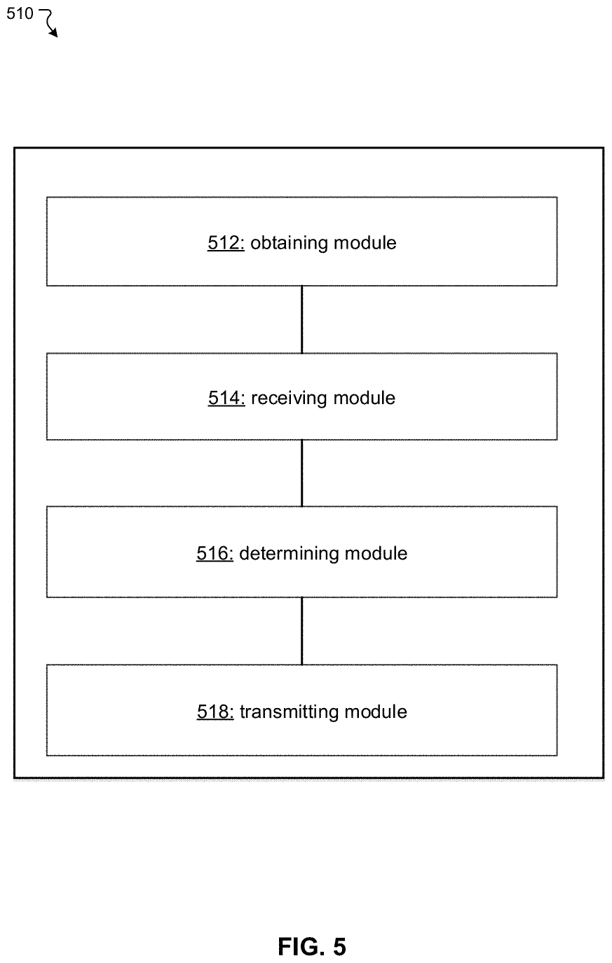

FIG. 5 illustrates a block diagram of an exemplary computer system 510 for resource-constrained recommendation, in accordance with various embodiments. The system 510 may be an exemplary implementation of the system 102 of FIG. 1A and FIG. 1B or one or more similar devices. The method 410 may be implemented by the computer system 510. The computer system 510 may include one or more processors and one or more non-transitory computer-readable storage media (e.g., one or more memories) coupled to the one or more processors and configured with instructions executable by the one or more processors to cause the system or device (e.g., the processor) to perform the method 410. The computer system 510 may include various units/modules corresponding to the instructions (e.g., software instructions). In some embodiments, the instructions may correspond to a software such as a desktop software or an application (APP) installed on a mobile phone, pad, etc.

In some embodiments, the computer system 510 may include an obtaining module 512 configured to obtain a model comprising an environment module, a resource allocation module, and a personal recommendation module. The environment module, the resource allocation module, and the personal recommendation module may correspond to instructions (e.g., software instructions) of the model. The environment module is configured to: cluster a plurality of users of a platform into a plurality of classes based on user contextual data of each user in the plurality of users, determine centric contextual information of each of the classes, output the centric contextual information of each of the classes to the resource allocation module, and output user contextual data of each individual user to the personal recommendation module. The resource allocation module comprises one or more first parameters of each of the classes and is configured to: determine probabilities of the platform making resource allocations to users in the respective classes, based on the one or more first parameters of each of the classes and the centric contextual information of each of the classes, and output the probability to the personal recommendation module. The personal recommendation module comprises one or more second parameters of each of the classes and is configured to: determine, based on user contextual data of an individual user, a corresponding class of the individual user among the classes, and the probabilities, a corresponding probability of the platform making a resource allocation to the individual user, determine, based on the one or more second parameters, different expected rewards corresponding to the platform executing different actions of making different resource allocations to the individual user in the corresponding class, select an action from the different actions according to the different expected rewards, wherein a probability of the platform executing the action is the corresponding probability, and output the selected action. The computer system 510 may further include a receiving module 514 configured to receive a real-time online signal of visiting the platform from a computing device of a visiting user; a determining module 516 configured to determine a resource allocation action by feeding user contextual data of the visiting user to the model as the individual user and obtaining the selected action as the resource allocation action; and a transmitting module 518 configured to, based on the determined resource allocation action, transmit a return signal to the computing device to present the resource allocation action.

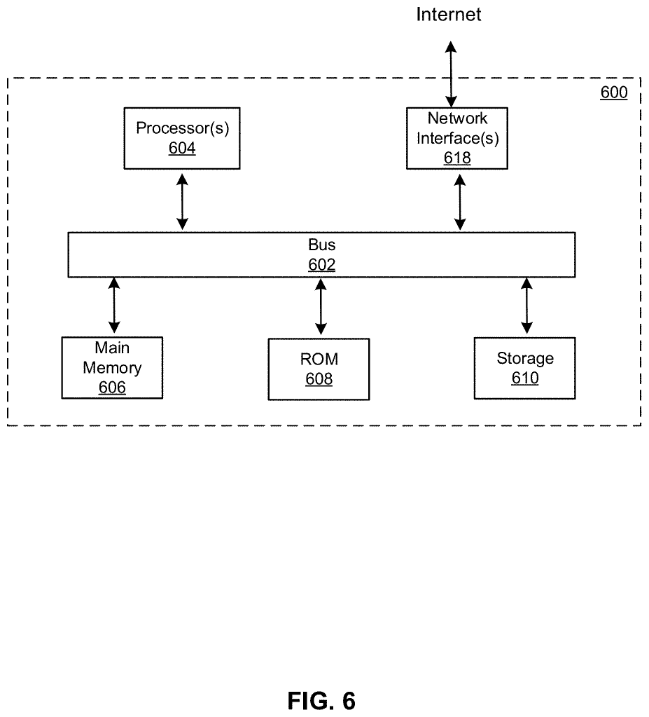

FIG. 6 is a block diagram that illustrates a computer system 600 upon which any of the embodiments described herein may be implemented. The system 600 may correspond to the system 102 or the computing device 109, 110, or 111 described above. The computer system 600 includes a bus 602 or another communication mechanism for communicating information, one or more hardware processors 604 coupled with bus 602 for processing information. Hardware processor(s) 604 may be, for example, one or more general-purpose microprocessors.

The computer system 600 also includes a main memory 606, such as a random access memory (RAM), cache, and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions. The computer system 600 further includes a read-only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may implement the techniques described herein using customized hard-wired logic, one or more ASICs or FPGAs, firmware, and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The main memory 606, the ROM 608, and/or the storage 610 may include non-transitory storage media. The term “non-transitory media,” and similar terms, as used herein refers to a media that stores data and/or instructions that cause a machine to operate in a specific fashion. The media excludes transitory signals. Such non-transitory media may include non-volatile media and/or volatile media. Non-volatile media includes, for example, optical or magnetic disks, such as storage device 610. Volatile media includes dynamic memory, such as main memory 606. Common forms of non-transitory media may include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge, and networked versions of the same.

The computer system 600 also includes a network interface 618 coupled to bus 602. Network interface 618 provides a two-way data communication coupling to one or more network links that are connected to one or more local networks. For example, network interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic, or optical signals that carry digital data streams representing various types of information.

The computer system 600 can send messages and receive data, including program code, through the network(s), network link, and network interface 618. In the Internet example, a server might transmit a requested code for an application program through the Internet, the ISP, the local network, and the network interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code modules executed by one or more computer systems or computer processors including computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The exemplary blocks or states may be performed in serial, in parallel, or in some other manner. Blocks or states may be added to or removed from the disclosed exemplary embodiments. The exemplary systems and components described herein may be configured differently than described. For example, elements may be added to, removed from, or rearranged compared to the disclosed exemplary embodiments.

The various operations of exemplary methods described herein may be performed, at least partially, by an algorithm. The algorithm may be included in program codes or instructions stored in a memory (e.g., a non-transitory computer-readable storage medium described above). Such algorithm may include a machine learning algorithm. In some embodiments, a machine learning algorithm may not explicitly program computers to perform a function, but can learn from training data to make a predictions model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS).

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the exemplary configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Although an overview of the subject matter has been described with reference to specific exemplary embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A computer-implemented method, comprising:
obtaining, by one or more computing devices, a model comprising an environment module, a resource allocation module, and a personal recommendation module, wherein:
the environment module is configured to cluster a plurality of users of a platform into a plurality of classes based on user contextual data of each individual user in the plurality of users, and to determine centric contextual information of each of the classes;
the resource allocation module comprises one or more first parameters of each of the classes and is configured to determine, based on the one or more first parameters of each of the classes and the centric contextual information of each of the classes, probabilities of the platform making resource allocations to users in the respective classes;
the personal recommendation module comprises one or more second parameters of each of the classes and is configured to:
determine, based on user contextual data of an individual user, a corresponding class of the individual user among the classes, and the probabilities, a corresponding probability of the platform making a resource allocation to the individual user,
determine, based on the one or more second parameters, different expected rewards corresponding to the platform executing different actions of making different resource allocations to the individual user in the corresponding class, and
select an action from the different actions according to the different expected rewards, wherein a probability of executing the selected action is the corresponding probability;
receiving, by the one or more computing devices, a real-time online signal of visiting the platform from a computing device of a visiting user;
determining, by the one or more computing devices, a resource allocation action by feeding user contextual data of the visiting user to the model as the individual user and obtaining the selected action as the resource allocation action; and
based on the determined resource allocation action, transmitting, by the one or more computing devices, a return signal to the computing device to present the resource allocation action.

2. The method of claim 1, wherein:
for a training of the model, the environment module is configured to receive the selected action and update the one or more first parameters and the one or more second parameters based at least on the selected action by feedbacking a reward to the resource allocation module and the personal recommendation module; and
the reward is based at least on the selected action and the probability of executing the selected action.

3. The method of claim 1, wherein:
the platform is a ride-hailing platform;
the real-time online signal of visiting the platform corresponds to a bubbling of a transportation order at the ride-hailing platform;
the user contextual data of the visiting user comprises a plurality of bubbling features of a transportation plan of the visiting user; and
the plurality of bubbling features comprise (i) a bubble signal comprising a timestamp, an origin location of the transportation plan of the visiting user, a destination location of the transportation plan, a route departing from the origin location and arriving at the destination location, a vehicle travel duration along the route, and a price quote corresponding to the transportation plan, (ii) a supply and demand signal comprising a number of passenger-seeking vehicles around the origin location, and a number of vehicle-seeking transportation orders departing from the origin location, and (iii) a transportation order history signal of the visiting user.

4. The method of claim 3, wherein:
the origin location of the transportation plan of the visiting user comprises a geographical positioning signal of the computing device of the visiting user; and
the geographical positioning signal comprises a Global Positioning System (GPS) signal.

5. The method of claim 3, wherein the transportation order history signal of the visiting user comprises one or more of the following:
a frequency of order transportation order bubbling by the visiting user;
a frequency of transportation order completion by the visiting user;
a history of discount offers provided to the visiting user in response to the order transportation order bubbling; and
a history of responses of the visiting user to the discount offers.

6. The method of claim 3, wherein:
the determined resource allocation action corresponds to the selected action and comprises offering a price discount for the transportation plan; and
the return signal comprises a display signal of the route, the price quote, and the price discount for the transportation plan.

7. The method of claim 6, further comprising:
receiving, by the one or more computing devices, from the computing device of the visiting user, an acceptance signal comprising an acceptance of the transportation plan of the visiting user, the price quote, and the price discount; and
transmitting, by the one or more computing devices, the transportation plan to a computing device of a vehicle driver for fulfilling the transportation order.

8. The method of claim 1, wherein:
the model is based on contextual multi-armed bandits; and
the resource allocation module and the personal recommendation module correspond to hierarchical adaptive contextual bandits.

9. The method of claim 1, wherein:
the action comprises making no resource distribution or making one of a plurality of different amounts of resource distribution; and
each of the actions corresponds to a respective cost to the platform.

10. The method of claim 1, wherein:
the model is configured to dynamically allocate resources to individual users; and
the personal recommendation module is configured to select the action from the different actions by maximizing a total reward to the platform, subject to a limit of a total cost over a time period, the total cost corresponding to a total amount of distributed resources.

11. The method of claim 1, further comprising training, by the one or more computing devices, the model by feeding historical data to the model, wherein each of the different actions is subject to a total cost over a time period, wherein:
the total cost corresponds to a total amount of distributed resource; and
the personal recommendation module is configured to determine, based on the one or more second parameters and previous training sessions based on the historical data, the different expected rewards corresponding to the platform executing the different actions of making the different resource allocations to the individual user.

12. The method of claim 1, wherein:
the resource allocation module is configured to maximize a cumulative sum of pⱼØⱼuⱼ;
pⱼ represents the probability of the platform making a resource allocation to users in a corresponding class j of the classes;
Øⱼ represents a probability distribution of the corresponding class j among the classes;
uⱼ represents an expected reward of the corresponding class j; and
a cumulative sum of pⱼØⱼ is no larger than a ratio of a total cost budget of the platform over a time period T.

13. The method of claim 12, wherein:
the one or more first parameters comprise the pⱼ and uⱼ.

14. The method of claim 12, wherein:
the resource allocation module is configured to determine the expected reward of the corresponding class j based on centric contextual information of the corresponding class j, historical observations of the corresponding class j, and historical rewards of the corresponding class j.

15. The method of claim 1, wherein:
the model is configured to maximize a total reward to the platform over a time period T; and
the model corresponds to a regret bound of O\sqrt{T}.

16. The method of claim 1, wherein:
if the corresponding class and the selected action exist in historical data used to train the model, the environment module is configured to identify a corresponding historical reward from the historical data as the reward; and
if the corresponding class or the selected action does not exist in the historical data, the environment module is configured to use an approximation function to approximate the reward.

17. The method of claim 1, wherein:
the platform is an information presentation platform;
the user contextual data of the visiting user comprises a plurality of visitor features of the visiting user;
the plurality of visitor features comprise one or more of the following: a timestamp of the real-time online signal of visiting the platform, a geographical location of the visiting user, biographical information of the visiting user, a browsing history of the visiting user, and a history of click response to different categories of online information;
the determined resource allocation action comprises one or more categories of information for display at the computing device of the visiting user; and
the return signal comprises a display signal of the one or more categories of information.

18. One or more non-transitory computer-readable storage media storing instructions executable by one or more processors, wherein execution of the instructions causes the one or more processors to perform operations comprising:
obtaining a model comprising an environment module, a resource allocation module, and a personal recommendation module, wherein:
the environment module is configured to cluster a plurality of users of a platform into a plurality of classes based on user contextual data of each individual user in the plurality of users, and to determine centric contextual information of each of the classes;
the resource allocation module comprises one or more first parameters of each of the classes and is configured to determine, based on the one or more first parameters of each of the classes and the centric contextual information of each of the classes, probabilities of the platform making resource allocations to users in the respective classes;
the personal recommendation module comprises one or more second parameters of each of the classes and is configured to:
determine, based on user contextual data of an individual user, a corresponding class of the individual user among the classes, and the probabilities, a corresponding probability of the platform making a resource allocation to the individual user,
determine, based on the one or more second parameters, different expected rewards corresponding to the platform executing different actions of making different resource allocations to the individual user in the corresponding class, and
select an action from the different actions according to the different expected rewards, wherein a probability of executing the selected action is the corresponding probability;
receiving a real-time online signal of visiting the platform from a computing device of a visiting user;
determining a resource allocation action by feeding user contextual data of the visiting user to the model as the individual user and obtaining the selected action as the resource allocation action; and
based on the determined resource allocation action, transmitting a return signal to the computing device to present the resource allocation action.

19. The one or more non-transitory computer-readable storage media of claim 18, wherein:
the platform is a ride-hailing platform;
the real-time online signal of visiting the platform corresponds to a bubbling of a transportation order at the ride-hailing platform;
the user contextual data of the visiting user comprises a plurality of bubbling features of a transportation plan of the visiting user; and
the plurality of bubbling features comprise (i) a bubble signal comprising a timestamp, an origin location of the transportation plan of the visiting user, a destination location of the transportation plan, a route departing from the origin location and arriving at the destination location, a vehicle travel duration along the route, and a price quote corresponding to the transportation plan, (ii) a supply and demand signal comprising a number of passenger-seeking vehicles around the origin location, and a number of vehicle-seeking transportation orders departing from the origin location, and (iii) a transportation order history signal of the visiting user.

20. A system comprising one or more processors and one or more non-transitory computer-readable memories coupled to the one or more processors and configured with instructions executable by the one or more processors to cause the system to perform operations comprising:
obtaining a model comprising an environment module, a resource allocation module, and a personal recommendation module, wherein:
the environment module is configured to cluster a plurality of users of a platform into a plurality of classes based on user contextual data of each individual user in the plurality of users, and to determine centric contextual information of each of the classes;
the resource allocation module comprises one or more first parameters of each of the classes and is configured to determine, based on the one or more first parameters of each of the classes and the centric contextual information of each of the classes, probabilities of the platform making resource allocations to users in the respective classes;
the personal recommendation module comprises one or more second parameters of each of the classes and is configured to:
determine, based on user contextual data of an individual user, a corresponding class of the individual user among the classes, and the probabilities, a corresponding probability of the platform making a resource allocation to the individual user,
determine, based on the one or more second parameters, different expected rewards corresponding to the platform executing different actions of making different resource allocations to the individual user in the corresponding class, and
select an action from the different actions according to the different expected rewards, wherein a probability of executing the selected action is the corresponding probability;
receiving a real-time online signal of visiting the platform from a computing device of a visiting user;
determining a resource allocation action by feeding user contextual data of the visiting user to the model as the individual user and obtaining the selected action as the resource allocation action; and
based on the determined resource allocation action, transmitting a return signal to the computing device to present the resource allocation action.
